(19) United States
(12) Patent Application Publication
(10) Pub. No.: US 2023/0323663 A1
(43) Pub. Date: Oct. 12, 2023

(54) A DEMOUNTABLE CASSETTE CONSTRUCTION SYSTEM

(71) Applicant: NATURAL BUILDING SYSTEMS LTD., Diss Norfolk (GB)

(72) Inventors: David NICHOLSON, Diss Norfolk (GB); Natasha GREENFIELD, Diss Norfolk (GB)

(21) Appl. No.: 18/027,077

(22) PCT Filed: Sep. 17, 2021
(86) PCT No.: PCT/GB2021/052420

§ 371 Date: Mar. 17, 2023

(30) Foreign Application Priority Data
Sep. 18, 2020 (GB) 2014783.1

(51) Int. Cl. E04B 2/00; E04C 2/284; E04C 2/38; E04B 5/02; B32B 3/06

(52) U.S. Cl. CPC E04C 2/46; E04C 2/284; E04C 2002/001; E04C 2/50; B32B 3/06; E04C 2/38

(57) ABSTRACT

This invention relates to a demountable cassette construction system for building a structure comprising one or more demountable cassettes, wherein the or each of the one or more demountable cassettes are attachable to one or more adjacent demountable cassettes via demountable joints, wherein the demountable joints permit the one or more demountable cassettes to be removed from a structure without removal of and/or damage to the or each of the one or more adjacent demountable cassettes.

### TECHNICAL FIELD

This invention relates to a demountable modular cassette construction system and individual cassettes used in the system. The invention also relates to a method of preparing the cassettes, a method of construction using the cassettes and/or the system, and a method of demounting the cassettes and/or system for deconstruction, disassembly or renovation. The invention extends to buildings and other structures made using the system.

### BACKGROUND

Modular building systems rely on the production of repeated sections of a building structure. Typically, production of the sections is remote from the building site. Such systems are also known as pre-fabricated building systems or off-site manufactured building systems.

The modules of the systems are arranged side-by-side, end-to-end, or stacked in some manner with joints therebetween to secure the modules to each other and provide a rigid structural framework fora building.

Modular building systems are widely used in a variety of construction contexts, improving the ease, and speed, of assembly of larger structures. With the majority of fabrication completed off-site, indoors, in more easily controlled factory conditions, benefits in terms of uninterrupted manufacture, quality control and automation may be achieved. Furthermore, economic advantages are realised through bulk purchasing of materials and lean manufacturing processes.

Modular systems broadly fall into two categories; panelised or volumetric. Panel systems are generally supplied flat-packed and so are appropriate where site access is constrained and/or there is little repetition, for example if the project is a ‘one off’ bespoke design. The downside of such systems is that more on-site assembly and finishing is required.

Volumetric systems better exploit the efficiencies of off-site production by enabling completed volumetric building elements to be finished in factory conditions, often with first fix, or even second fix components already installed, resulting in the better quality control, much improved health and safety, and reducing waste and sequencing issues (sequencing in this context meaning managing different trades so that they do not conflict with each other, i.e. different trades in the same work area, or out of sequence works.

Typically, modular systems comprise some form of structural frame with infill insulation and space for main services such as electrical wiring and plumbing. The most common of such systems are Structural Insulated Panels or SIPs.

SIPs are relatively simple in construction, typically comprising laminate or wood fibre surface sheets, often oriented strand board (OSB) sheets, on each side of a foam insulation core that is typically between 10 cm and 20 cm thick. However, the foam is typically derived from non-renewable petrochemical products, such as expanded polystyrene (EPS), extruded polystyrene (XPS) and polyurethane foam (PUR). The panels are then assembled on site using petroleum-derived epoxy resin glues and high carbon footprint metal screws and nails. This means SIPs have high embodied carbon/negative environmental impacts. Even the OSB board typically comprises the binder methylene diphenyl diisocyanate (MDI), diisocyanates being well known dermal and inhalation sensitizers.

Other modular systems comprise steel studwork frames and rigid wood fibre facings enclosing insulation material, as are concrete wall panels, but both of which suffer from even worse embodied carbon/negative environmental impacts than SIPs.

Alternative modular building systems that have a lower carbon footprint are known, for example:
Timber-frame panels—panel systems comprising stud frames and facing materials such as OSB, enclosing a variety of natural and non-mineral insulation products.
Engineered laminate timber panel systems:
   panel and volumetric systems which form building elements using frames produced from Cross Laminated Timber (CLT) or GluLam (Glued-Laminated) timber enclosing insulation with rigid wood fibre panels, such as OSB fixed to the outside;
   primary structure systems using beams comprised of engineered wood products such as GluLam or Laminated Veneer Lumber to which modular panels can be attached.

However, none of the above solutions have good hygrothermic characteristics, i.e. the ability of the building fabric to passively absorb and equalize humidity, thereby improving thermal comfort and reducing the need for mechanical ventilation.

Hemp-lime is a construction material with good insulation properties. Hemp-lime combines renewable low carbon materials with exceptional hygrothermal performance. SIPs based on the use of hemp-lime are known. The Biond™ system (https://www.biond.co.uk/wp-content/uploads/biond_laymans-guide.pdf; accessed 21 Aug. 2020) comprises large, bespoke panel elements with a hemp lime aggregate infill. However, the system suffers from numerous disadvantages, for example:
The panels must be manufactured in a bespoke manner for each individual project, not allowing manufacturing economies of scale by utilising repeatable pre-manufactured components;
It can only be delivered in panel form, with finishes applied on site, thereby not benefiting from the full advantages of off-site construction;
The substructure of a building made with the system is conventional, typically with portland cement-based footings, petrochemical-derived damp-proof membranes (DPM), and extensive groundworks etc.
The use of hemp-lime aggregate requires intensive drying, which increases the embodied carbon of the material. Lime itself has also relatively high embodied carbon (albeit partially offset over time through carbonisation);
The system is not demountable, which means alterations during the building's lifetime can only be done by conventional demolition/deconstruction leading to waste, and with limited opportunity for end-of-life recycling.

A specific prefabricated construction systems is known, for example in U.S. Pat. No. 2,666,233A. This system follows a conventional timber framed structure onto which timber panels (formed from transverse lengths of tongue and groove (T&G lumber) are fixed for both wall and floor elements. Insulation does not play any part in the design. Although described as ‘demountable’ individual floor panels cannot be removed without significant deconstruction since the sealing strip can't be removed without removing all the adjacent panels in the reverse sequence in which they were installed. Wall panels are demountable but at the expense of air tightness since there is no sealing strip. Disadvantages of this system would be:
1. Poor thermal performance due to numerous cold bridges and lack of insulation;
2. Poor air tightness where the panels have no sealing strip;
3. Low thermal mass of the materials leading to very limited thermal buffering;
4. Poor hygric performance of timber elements (actually not applicable due to insufficient air tightness);
5. In short, the system would not come close to complying with contemporary building regulations.

Demountable structural panels comprise demountable joints and/or fixings that allow for ready removal of individual or groups of panels with no, or minimal unnecessary demolition or deconstruction.

US2017/0121961, US2647287 and US2009/0188188 all relate to demountable panel construction systems. Each describes a system that makes use of joints between the panels that are not formed of biodegradable materials, typically use of jointing components formed of metal or plastics are described.

EP0890681 describes a building system that uses wooden panel components joined by means of a connecting strip. In a preferred embodiment, the connecting strip is a peg that is inserted in two opposing undercut grooves in the surfaces to be joined. However, the structural rigidity of the building system relies on expansion of the strip in the joint after insertion through absorption of moisture meaning that these strips are not easily removed after installation and therefore the panels are not readily demountable.

There exists a need therefore for an improved structural insulated panel building system that combines the advantages of traditional modular panel building systems with use of materials that have a low carbon footprint/environmental impact, have good hygrothermic properties and are readily demountable to provide for simple routes to deconstruction, re-configuration, disassembly and renovation of buildings built using the system.

### SUMMARY OF INVENTION

In a first aspect the invention provides a demountable cassette construction system for building a structure comprising one or more demountable cassettes, wherein the or each of the one or more demountable cassettes are attachable to one or more adjacent demountable cassettes via demountable joints, wherein the demountable joints permit the one or more demountable cassettes to be removed from a structure without removal of and/or damage to the or each of the one or more adjacent demountable cassettes.

In an embodiment, the demountable joints consist of biodegradable components, or the joints are substantially or entirely biodegradable as herein defined. Suitably, the demountable joints consist of, or are formed substantially or entirely of, wooden components. Suitably, the demountable joints lack any non-biodegradable fixings selected from the group consisting of: screws, nails, non-wooden or plastic brackets, and combinations thereof.

In embodiments, the demountable joints are selected from the group consisting of: split-batten joints; scarf joints and spline joints. Suitably, the scarf-joints are scarf lock joints. Suitably, the spline joints are bow-tie joints.

In embodiments, the or each of the one or more demountable cassettes further comprises a demountable means of alignment with the or each of the one or more adjacent demountable cassette. Suitably, the means of alignment is a removeable tongue on the or each of the one or more demountable cassettes and a corresponding groove on the or each of the one or more adjacent cassettes. Suitably, the removeable tongue is removeable from within an interior volume of the or each of the one or more demountable cassettes.

In embodiments, the one or more demountable cassettes are selected from the type consisting of: wall cassette, floor cassette, intermediate floor cassette, roof cassette and junction cassette.

In embodiments, the system comprises:
a) At least one floor cassette;
b) At least two wall cassettes;
c) At least one roof cassette.

In a second aspect, the invention provides a demountable cassette for use in a demountable cassette construction system of the first aspect of the invention.

In embodiments, the cassette comprises:
a) An inner cassette, the inner cassette comprising: a base; a lid; two opposing, generally parallel end panels, and two opposing, generally parallel side panels arranged to enclose an interior space, wherein the interior space contains insulation;
b) An outer cassette surrounding an exterior of, and affixed to, the inner cassette, the outer cassette comprising at least one end panels, and two opposing, generally parallel side panels;
c) at least one demountable joint, or part thereof, for joining the demountable cassette to an adjacent structure.

In embodiments, the at least one demountable joint, or part thereof, is positioned on a part of cassette selected from the group consisting of: an end panel of the outer cassette; a side panel of the outer cassette, or a combination of both.

In embodiments, the adjacent structure is another demountable cassette of the present invention or another suitable structure, such as an existing wall or exterior of a building. Suitably, the adjacent structure is selected from the group consisting of: a demountable cassette; a junction cassette; a lintel; a floor joist; and a plinth or combinations thereof.

In embodiments, the cassette comprises a demountable means of alignment on at least one of the side panels of the outer cassette. In embodiments, the cassette comprises a demountable means of alignment on at least one of the end panels of the outer cassette. In embodiments, the cassette comprises a demountable means of alignment on at least one of the end panels of the outer cassette and on at least one of the end panels of the outer cassette.

In embodiments, the cassette is of a type selected from the group consisting of: a wall cassette; a floor cassette; and a roof cassette. Suitably, when the cassette is a floor cassette or a roof cassette, the demountable joints on the end panel support the weight of the cassette in use.

In embodiments, the insulation fills the interior space of the inner cassette.

In embodiments, the lid and/or base of the inner cassette permits the passage of water vapour between the insulation and the surrounding air. In these embodiments, the insulation is breathable and/or has good hygrothermal properties. Suitably, the inner cassette comprises apertures in the lid and/or the base, or the lid and/or base of the inner cassette is vapour permeable, to provide contact of the insulation with the surrounding air.

Suitably, the insulation extends into the apertures in the lid and/or base of the inner cassette, when said apertures are present.

In a third aspect, the invention provides a method for preparing a demountable cassette for use in a demountable cassette construction system, the method comprises the steps of:
a) providing an open inner cassette, wherein the inner cassette comprises a lid;
b) installing one or more insulation blocks into the inner cassette and affixing the lid to provide an inner cassette;
c) affixing an outer cassette to at last partially surround the inner cassette, the outer cassette having walls that extend upwardly from a top of the inner cassette such that a void is provided within the volume defined by the outer cassette; the outer cassette having at least one demountable joint, or part thereof, for joining the demountable cassette to an adjacent structure.

In embodiments, the method comprises the steps after step (b) of:
c) installing insulation in the void;
d) affixing a finishing board at least one face of the outer cassette.

In a fourth aspect, the invention provides a method for installing a vertically mounted cassette as part of a demountable cassette construction system, the method comprising the steps of:
a) providing a first cassette, wherein the first cassette comprises an inner cassette and an outer cassette, the outer cassette comprising one or more open channels; one or more tongue strips; and one or more grooves;
b) providing a second cassette, wherein the second cassette comprises an inner cassette and an outer cassette, the outer cassette comprising one or more open channels; one or more tongue strips; and one or more grooves;
c) installing the first cassette by aligning the first cassette such that at least one of the one or more tongue strips on the outer cassette aligns with and engages at least one of the one or more grooves on the second cassette,
   wherein at least one of the or each of the one or more open channels on the outer cassette of the first cassette aligns with at least one of the one or more open channels on the second cassette to form a slot;
d) insert splines into the slots to join the first cassette to the second cassette.

In embodiments, the method further comprises one or more of the following steps after step (d):
a) install mechanical and electrical services as required;
b) install further insulation in the outer cassette as required;
c) install finishing boards to a top face and/or a bottom face of the cassette.

In a fifth aspect, the invention provides a method of demounting a vertically-mounted cassette as part of a demountable cassette construction system, the method comprising the steps of:
a) providing an installed first cassette adjacent and fixed to a second cassette,
   wherein the first cassette comprises an inner cassette and an outer cassette, the outer cassette comprising one or more open channels one or more tongue strips; and one or more grooves, and the second cassette comprises an outer cassette, the outer cassette comprising one or more open channels one or more tongue strips; and one or more grooves,
   wherein at least one of the one or more open channels of the first cassette and at least one of the one or more open channels of the second cassette align to provide one or more slots, wherein in the one or more slots is inserted one or more splines that hold the first cassette and the second cassette together; and
   wherein at least one of the one or more tongue strips of the first cassette are engaged with at least one of the one or more grooves on the second cassette;
b) removing the splines from the one or more slots;
c) accessing the interior of the outer cassette of the first cassette;
d) releasing the one or more tongue strips on the first cassette;
e) removing the first cassette.

In embodiments, step (b) and steps (c) to (d) may be reversed.

In embodiments, the vertically mounted cassette is a wall cassette.

In embodiments, finishing in step (e) comprises fitting any external boarding and/or insulation and/or cladding to a given face of the cassette dependent on its intended purpose.

In a sixth aspect, the invention provides a method of installing a horizontally mounted cassette as part of a demountable cassette construction system, the method comprising the steps of:
a) providing a first cassette, wherein the first cassette comprises an inner cassette and an outer cassette, the outer cassette comprising one or more open channels; one or more tongue strips, and one or more grooves;
b) providing a second cassette, wherein the second cassette comprises an inner cassette and an outer cassette, the outer cassette comprising one or more open channels; one or more tongue strips, and one or more grooves;
c) installing the first cassette by aligning to the second cassette such that at least one of the one or more tongue strip on the first cassette aligns with and engages with at least one of the one or more grooves on the second cassette, and engaging the first cassette on to demountable to located at an end of the first cassette and an end of the second cassette, wherein at least one of the one or more open channels on the first cassette aligns with at least one of the one or more of the open channels on the second cassette to form a slot;
d) insert splines into the slots to join the first cassette to the second cassette;
e) install finishing boards to the first cassette.

In embodiments, the horizontally mounted cassette is a floor cassette, or a roof cassette.

In embodiments, finishing in step (e) comprises fitting any external boarding and/or insulation and/or cladding to a given face of the cassette dependent on its intended purpose.

In a seventh aspect, the invention provides a method of demounting a horizontally mounted cassette as part of a demountable cassette construction system, the method comprising the steps of:
a) providing an installed first cassette adjacent and fixed to a second cassette,
   wherein the wall cassette comprises an inner cassette and an outer cassette, the outer cassette comprising one or more open channels; one or more tongue strips; and one or more grooves; and the second cassette comprises an inner cassette and an outer cassette, the outer cassette comprising one or more open channels one or more tongue strips, and one or more grooves,
   wherein at least one of the open channels of the first cassette and at least one of the one or more open channels of the second cassette align to provide one or more slots, wherein in the one or more slots is inserted one or more splines that hold the first cassette and the second cassette together; and
   wherein at least one of the one or more tongue strips of the first cassette are engaged with at least one of the one or more grooves on the second cassette;
b) removing the one or more splines from the one or more slots;
c) accessing an interior of the outer cassette of the first cassette;
d) releasing the or each of the one or more tongue strips affixed to the outside of the first cassette;
e) lifting the first cassette thereby separating the one or more demountable joints.

In embodiments, step (c) and steps (d) to (f) may be reversed.

In embodiments, the horizontally mounted cassette is a floor cassette, or a roof cassette.

In an eighth aspect, the invention provides a method of assembling a building structure using the system of the first aspect of the invention or one or more of the cassettes of the second aspect of the invention.

In a ninth aspect, the invention provides a building structure assembled using the method of the third aspect of the invention or the method of the fifth aspect of the invention or using the system of the first aspect of the invention or one or more of the cassettes of the second aspect of the invention. Suitably, the building structure is over 18 metres high.

In a tenth aspect, the invention provides a method of deconstructing, demolishing, reconfiguring, renovating or extending a building structure previously assembled using the system of the first aspect of the invention or the cassette of the second aspect of the invention, the method comprising the steps of the fourth aspect of the invention.

In an eleventh aspect is a system for removably joining two surfaces together, the system comprising:
a. a split peg, wherein the split peg comprises;
   i. a central portion having a retrieval means; and
   ii. a first shaped outer piece;
   iii. a second shaped outer piece
   wherein the first shaped outer piece and the second shaped outer piece are arranged around, suitably on opposite sides of, the central portion;
b. a first channel or slot in a first surface to be joined, wherein the first channel has an opening in the first surface and a base, wherein the opening is narrower than the base, and wherein in cross-section the first channel has a shape that is complimentary to a first portion, suitably a first half, of the split peg; and
c. a second channel or slot in a second surface to be joined, wherein the second channel has an opening in the second surface and a base, wherein the opening is narrower than the base, and wherein in cross-section the second channel has a shape that is complimentary to a second portion, suitably a second half, of the split peg;

In a twelfth aspect, the invention provides a method of joining two surfaces using of the system of the eleventh aspect wherein (1) a split peg, a first channel and a second channel are provided; (2) the first surface and the second surface are abutted such that the opening of the first channel and the opening of the second channel align to form a slot, and (3) the split peg is inserted into the slot thereby joining the two surfaces together.

In a thirteenth aspect, the invention provides a method of removing a split peg of the eleventh aspect to release a first surface and a second surface from being joined, wherein (1) the central portion is removed from the slot by attaching a suitable tool to the retrieval means and applying an extractive force; (2) removing the first outer piece of the split peg by releasing it into the space vacated by the central portion; and (3) removing the second outer piece of the split peg by releasing it into the space vacated by the central portion.

In embodiments of the eleventh, twelfth and thirteenth aspect, the central portion is generally rectangular or square with a first face, and a second face, wherein the second face is generally opposing and parallel to the first face. Suitably, the first shaped piece is configured to abut the front face of the central block and the second shaped outer piece is configured to abut the rear face of the central block when the split peg is assembled.

In embodiments, when assembled the split peg has a cross-sectional shape perpendicular to a longitudinal axis that runs along the length of the peg of a typical bow-tie or butterfly peg well-known in joinery, i.e. a concave hexagon or an irregular hexagonal shape wherein the distance between one pair of opposing vertices is less than the distance between the other two pairs of opposing vertices), i.e. a shape such as:

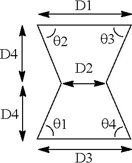

wherein the length of D2<D1, and suitably D1=D3 and/or D4=D5 and/or ⊖1=⊖2 and/or ⊖3=⊖4;

In embodiments, the central block is formed of a low frictional resistance material, such as planed-all-round (PAR) timber or a bio-resin to reduce friction on removal.

In embodiments, the retrieval means in the central block can be any means suitable for extractive removal of the central block when installed. Suitably, the retrieval means is a channel formed part way along a longitudinal axis of the central block. Suitably, the channel terminates at a first end at an opening on an end face of the central block that is exposed when the split peg is inserted and terminates at a second end of the channel is a widened chamber. In use, a split peg removal tool can be removably inserted through the channel to the widened chamber and extractive pressure applied to the central block, for example by leverage against an adjacent surface or pulling.

In a fourteenth aspect, the invention provides a split peg removal tool that comprises: (1) a frame; (2) an elongate drive member mounted in, and able to move linearly within, the frame, the drive member comprising (1) linear gear teeth located at or near a proximal end within the frame, and (2 at a distal end outside of the frame, a widened tip that is generally thinner in a first dimension perpendicular to the longitudinal axis of the drive member, than a second dimension perpendicular to the longitudinal axis of the drive member; (2) leverage means, such as elongate arms, mounted on the frame, the leverage means having rotating gear teeth that engage the linear gear teeth, such that on rotation of the leverage means, the drive member is moved linearly in the frame via the engaging action of the linear gear teeth and the rotating gear teeth thereby at least partially extracting the central block

### BRIEF DESCRIPTION OF THE DRAWINGS

One or more embodiments of the invention will now be described, by way of example only, with reference to the accompanying drawings, in which:

FIG. 1 shows an overview of the modular system components in accordance with an embodiment of the present invention.

FIG. 2 shows a two-storey construction using a demountable modular construction system in accordance with an embodiment of the present invention.

FIG. 3 shows a multiple-storey construction using a demountable modular construction system in accordance with an embodiment of the present invention.

FIG. 4 shows: (a) an exploded perspective view of a demountable floor cassette in accordance with an embodiment of the present invention; (b) shows a sectional view of the demountable floor cassette shown in FIG. 4(a); (c) an exploded perspective view of a demountable floor cassette in accordance with a further embodiment of the present invention; and (d) shows a sectional view of the demountable floor cassette shown in FIG. 4(c). FIG. 4(d)(i) shows an Ultra-Low Energy variant of the cassette in which the insulation layer in the outer cassette is approximately 150 mm in thickness, and the insulation in the inner cassette is approximately 120 mm in thickness; FIG. 4(d)(ii) shows a Low Energy variant of the cassette in which the insulation layer in the outer cassette is approximately 100 mm in thickness, and the insulation in the inner cassette is approximately 120 mm in thickness; and FIG. 4(d)(iii) shows a Slim variant of the cassette in which the insulation layer in the outer cassette is approximately 60 mm in thickness, and the insulation in the inner cassette is approximately 70 mm in thickness.

In all embodiments shown in FIGS. 4(b) and 4(d), the cassette is oriented on installation so that the inner cassette faces the outside of the building.

FIG. 5 shows: (a) an exploded perspective view of a demountable roof cassette in accordance with an embodiment of the present invention; (b) shows a sectional view of the demountable roof cassette shown in FIG. 5(a). FIG. 5(b)(i) shows an Ultra-Low Energy variant of the cassette in which the insulation layer in the outer cassette is approximately 150 mm in thickness, and the insulation in the inner cassette is approximately 120mm in thickness, this cassette achieves a calculated U-value of 0.13; FIG. 5(b)(ii) shows a Low Energy variant of the cassette in which the insulation layer in the outer cassette is approximately 100 mm in thickness, and the insulation in the inner cassette is approximately 120 mm in thickness, this cassette achieves a calculated U-value of 0.16; and FIG. 5(b)(iii) shows a Slim variant of the cassette in which the insulation layer in the outer cassette is approximately 60 mm in thickness, and the insulation in the inner cassette is approximately 70 mm in thickness, this cassette achieves a calculated U-value of 0.25. In all embodiments shown in FIGS. 5(b), the cassette is oriented on installation so that the inner cassette faces the inside of the building.

FIG. 6 shows: (a) an exploded perspective view of a demountable wall cassette in accordance with an embodiment of the present invention; (b) shows a sectional view of the demountable wall cassette shown in FIG. 6(a); (c) an exploded perspective view of a demountable wall cassette in accordance with a further embodiment of the present invention; and (d) shows a sectional view of the demountable wall cassette shown in FIG. 6(c). FIG. 6(d)(i) shows an Ultra-Low Energy variant of the cassette in which the insulation layer in the outer cassette is approximately 150 mm in thickness, and the insulation in the inner cassette is approximately 120 mm in thickness, this cassette achieves a calculated U-value of 0.13; FIG. 6(d)(ii) shows an Internal variant intended for use in internal stud walling and as such requires no external cladding, in which the insulation layer in the outer cassette is approximately 60 mm in thickness, and the insulation in the inner cassette is approximately 88 mm in thickness; FIG. 6(d)(iii) shows a Low Energy variant of the cassette in which the insulation layer in the outer cassette is approximately 100 mm in thickness, and the insulation in the inner cassette is approximately 120 mm in thickness, this cassette achieves a calculated U-value of 0.16; and FIG. 6(d)(iii) shows a Slim variant of the cassette in which the insulation layer in the outer cassette is approximately 60 mm in thickness, and the insulation in the inner cassette is approximately 88 mm in thickness, this cassette achieves a calculated U-value of 0.25. In all embodiments shown in FIGS. 6(b) and 6(d), the cassette is oriented on installation so that the inner cassette faces the inside of the building.

FIG. 7 shows an exploded perspective view of a demountable intermediate floor cassette in accordance with an embodiment of the present invention.

FIG. 8 shows: (a) an exploded perspective view; and (b) a sectional view of a demountable roof cassette in accordance with an embodiment of the present invention. In the embodiment shown in FIG. 8(a), the cassette is oriented on installation so that the inner cassette faces the inside of the building.

FIG. 9 shows an exploded perspective view of two demountable roof cassettes in accordance with an embodiment of the present invention joined via a load-bearing scarf lock joint.

FIG. 10 shows an exploded perspective view of two demountable intermediate floor cassettes in accordance with an embodiment of the present invention joined via a load-bearing scarf lock joint.

FIG. 11 shows: (a) a perspective view of a removable tongue and groove feature of a cassette in accordance with an embodiment of the present invention; and (b) a perspective view of a removable tongue and groove feature of a cassette in accordance with a further embodiment of the present invention.

FIG. 12 shows two demountable cassettes in accordance with the present invention i) separated; and (ii) joined using the bow-tie type spline joints of the present invention.

FIG. 13 shows: (a) a series of perspective views of a removable spline joint feature and a tool for removal from the inside of a building in accordance with an embodiment of the present invention; (b) a series of perspective views of a removable spline joint feature and a tool for removal from the outside of a building in accordance with an embodiment of the present invention; (c) a split peg and corresponding removal tool in accordance with an aspect of the present invention; and (d) a series of perspective views of the split peg and corresponding removal tool of FIG. 13(c).

FIG. 14 shows: (a) a perspective detail view of a demountable scarf lock joint feature of a cassette in accordance with an embodiment of the present invention; (b) a perspective detail view of a demountable scarf lock joint feature and a lock plate in accordance with an embodiment of the present invention; and (c) a perspective detail view of a demountable scarf lock joint feature when assembled in a building structure.

FIG. 15 shows (a) a top, front, left; and (b) a bottom, front, left perspective view of a demountable split batten joint between a floor cassette and an optional junction cassette in accordance with an embodiment of the present invention.

FIG. 16 shows: (a) assembly details of assembly of two floor cassettes with lintel construction, and two roof cassettes and a demountable scarf joint in accordance with embodiments of the present invention; (b) a top, front, right view of a demountable split batten joint between a floor cassette and an optional junction cassette, and a split batten joint on a lintel construction, in accordance with an embodiment of the present invention; and (c) a bottom, front, left perspective view of a demountable split batten joint between a floor cassette and an optional junction cassette, and a scarf lock joint, in accordance with an embodiment of the present invention.

FIG. 17 shows: (a) an exploded sectional perspective view of a portion of an inner cassette in accordance with an embodiment of the present invention; and (b) an alternative exploded sectional perspective view of a portion of an inner cassette in accordance with an embodiment of the present invention.

FIG. 18 shows a partial perspective view of a floor cassette in accordance with an embodiment of the present invention joined, via an optional junction cassette, to a wall cassette showing the outer cassette details of each.

FIG. 19 shows a cross-sectional view of a floor cassette in accordance with an embodiment of the present invention joined, via an optional junction cassette, to a wall cassette.

FIG. 20 shows an exploded perspective view of a cladding frame and rigid insulation of a wall cassette in accordance with an embodiment of the present invention.

FIG. 21 shows: (a) an exploded perspective view of a demountable rain screen cladding feature of a wall cassette in accordance with an embodiment of the present invention; (b) an exploded perspective view of an alternative embodiment of a demountable rain screen cladding feature of a wall cassette in accordance with an embodiment of the present invention; and (c) a detail view of the mounting system for a demountable rain screen cladding feature of a wall cassette in accordance with an embodiment of the present invention.

### Definitions

For convenience, before further description of the present disclosure, certain terms employed in the specification, and examples, are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles ‘a’, ‘an’ and ‘the’ are used to refer to one or to more than one (i.e. to at least one) of the grammatical object of the article.

As used herein, the term ‘comprising’ means any of the recited elements are necessarily included and other elements may optionally be included as well. ‘Consisting essentially of’ means any recited elements are necessarily included, elements which would materially affect the basic and novel characteristics of the listed elements are excluded, and other elements may optionally be included. ‘Consisting of’ means that all elements other than those listed are excluded. Embodiments defined by each of these terms are within the scope of this invention. The term ‘comprising’, when used in respect of certain components of the composition, should be understood to provide explicit literal basis for the term ‘consisting essentially of’ and ‘consisting of’ those same components.

As used herein, the term ‘biodegradable’ means capable of being broken down in nature and/or by the action of living things. The term is used herein to refer to compositions, or components of compositions, that naturally break down to innocuous constituents in water or in aqueous or wet environments, typically through dissolving or through the action of naturally occurring microorganisms such as bacteria or fungi.

As used herein, a ‘cassette’ refers to a structural building panel used for the construction of a building or other structure. The term ‘cassette’ may be used interchangeably herein with the term ‘panel’, ‘structural insulated panel’ and ‘module’. The terms ‘inner cassette’ and ‘outer cassette’ as used herein refer to component structures of the cassette as defined hereinbelow.

As defined herein, a ‘structural insulated panel’ or ‘SIP’ is a construction panel that in its most general form is a construction panel comprising two layers of structural or engineering board with a layer of rigid insulation between. SIPs share the same structural properties as an I-beam with the insulation acting as a web between the board flanges. Traditional SIPs make use of rigid insulation derived from petroleum such as expanded polystyrene foam or polyisocyanurate foam and therefore have a high carbon footprint. Furthermore, while SIPs may be manufactured off-site, the method of assembly generally requires overlap of the exterior boards with another panel prior to fixing using nails or screws. Once assembled, the surfaces of the boards are then generally covered with plaster and/or render meaning the panels are not readily demountable for disassembly or demolition.

As used herein, the term ‘joint’ refers to a connection between two objects. The joint is comprised of the structural components that form the joint, such as the complimentary shaped channels of a lock mitre joint, a wooden split batten or a bow tie peg. Joints may be supplemented in some cases with further strengthening or bonding components such as dowels or glue that act to strengthen the joint of assist in binding the joint together. These further strengthening or bonding components are not part of the ‘joint’, as defined herein, although may support, fix or strengthen the joint. If used in the present invention, further strengthening or bonding components are suitably chosen from biodegradable materials such that the joint, plus the further strengthening or bonding components, remains entirely or at least substantially biodegradable. As used herein the term ‘joint’ or ‘demountable joint’ (see below) may refer to a subset, or part of a joint, when only that part is present on the object described. The subset or part of the joint will form the full or complete joint when engaged with the other part or parts of the joint.

As used herein, the term ‘demountable’ means able to be dismantled or removed from its setting and readily reassembled or repositioned. The term may be used interchangeably with ‘fixing-less’ or ‘without independent fixings’. Demountable may be defined by the number of panels or cassettes that are required to be accessed, deconstructed or dismantled to enable removal of a single panel or cassette. Suitably, to be demountable, an individual cassette may be considered demountable, or readily demountable, if no more than four cassettes (not including itself), need to be accessed to free the individual cassette. Suitably, no more than 3, 2 or the individual panel itself need to be accessed to demount the individual cassette. The fewer number of cassettes that need to be accessed means the lower degree of deconstruction, and therefore disruption caused to the remaining structure after removal.

As used herein, the term ‘demountable joint’ means a connection, join or coupling between two adjacent cassettes that holds the cassettes together, yet is able to be readily dismantled. A joint is a fixing between two components and does not extend to a means of alignment.

As used herein, the term tygrothermar refers to the movement of heat and moisture, in particular through buildings. Good hygrothermal properties generally mean the ability of a material to allow passage of water vapour to regularise and moderate the humidity conditions in a building, while preventing or mitigating heat loss through conduction or allow air volume to pass.

As used herein, the term ‘aggregate’ means coarse- to medium-grained particulate material used to make concrete and in construction, including sand, gravel, crushed stone, slag, recycled concrete and geosynthetic aggregates. As used herein, the term “bio-aggregate” refers to plant-derived substitution materials for aggregates, such as plant-based shiv, for example hemp shiv. Bio-aggregates suitable for use in concrete substitutes may be larger than the bio-aggregates used for replacement of finer cement-based materials such as mortars or plaster. Larger bio-aggregates may be in the region of 15-25 mm particles, with smaller bio-aggregates may be in the region of 2-5 mm particle sizes. The measurement of particle sizes for shiv and other bio-aggregates is often complicated by the fact that the particles vary in size and shape and are often elongated. One suitable method for measurement of particle size of bio-aggregates is by the average particle size by weight, measured by a sieving method. Such a method is described, for example, in section 4.5.2.3 of “Recommendation of the RILEM TC 236-BBM: characterisation testing of hemp shiv to determine the initial water content, water absorption, dry density, particle size distribution and thermal conductivity; Amziane et al., Materials and Structures (2017); 50:167 (https://hal-univ-rennestarchives-ouvertes.fr/hal-01523118/document; accessed 3 Aug. 2020). A sample of the bio-aggregate is tested in a sieving apparatus in accordance with EN 932-5, comprising sieves with incrementally decreasing apertures (the apertures being in accordance with EN 933-2). From the increase in weight of each sieve the distribution of particle sizes allows for a weight average size to be obtained. Alternatively, from the same data, the particle size can be given as a set cumulative amount passing a given size, for example, 90% of the particles are less than 25 mm is size, although any cumulative percentage, or combination of cumulative percentages that provides details of the particle size distribution of the bio-aggregate is appropriate. Such sieve data may be supplemented by image analysis data to further define the particle size and shape of the bio-aggregate.

As used herein, the term ‘breathable’ or ‘breathability’ means the ability of a fabric or material to allow moisture or water vapour to be transmitted therethrough. This is in contrast to ‘air permeability’ which is the ability of a fabric or material to allow air to pass through. Air permeability in insulation for example may be detrimental to heat retention, whereas a breathable insulation may retain heat while allowing passage of water vapour. Breathability may be measured by any known standard vapour permeability or vapour resistance method. The vapour resistance of a material is a measure of the material's reluctance to let water pass through. Vapour resistance is dependent on the material's thickness and so any value for vapour resistance must be quoted for a particular thickness or normalised to a given unit thickness. The unit of vapour resistance is commonly mega-Newton seconds per gram, or MNs/g. One commonly used measure of vapour resistance of a material is the μ-value, this is the water vapour resistance factor. The μ-value of a material is the ratio between the water vapour permeability of air at 23° C. and 1 bar, and the water vapour permeability of the material. As the μ-value is a relative quantity it is expressed as a number with no units and is used as a multiplier to the materials final thickness

As used herein, the term ‘carbon footprint’ means the carbon footprint of a product, for example the binder, and is the full inventory of all greenhouse gas emissions released throughout the production of a product or service, from the extraction of its raw materials to leaving the production facility (sometimes referred to as ‘cradle-to-gate’). It is expressed in carbon dioxide equivalents (CO₂e). The products may be certified to internationally recognised standards for carbon footprint such as the GHG Protocol Standard, ISO 14067 and PAS 2050.

As used herein, the term ‘carbon dioxide equivalent’ or ‘CO₂e’ is a standard unit for measuring carbon footprints. This allows the expression of the impact of each different greenhouse gas in terms of the amount of CO₂ that would create the same amount of global warming. In this way, a carbon footprint consisting of lots of different greenhouse gases can be expressed as a single number. Standard ratios are used to convert the various gases into equivalent amounts of CO₂. These ratios are based on the so-called global warming potential (GWP) of each gas, which describes its total warming impact relative to CO₂ over a set period—typically one hundred years. Over this time frame, according to the standard data (for example, “Forster, P., et al, 2007: Changes in Atmospheric Constituents and in Radiative Forcing. In: Climate Change 2007: The Physical Science Basis. Contribution of Working Group I to the Fourth Assessment Report of the Intergovernmental Panel on Climate Change [Solomon, S., D. Qin, M. Manning, Z. Chen, M. Marquis, K. B. Averyt, M. Tignor and H. L. Miller (eds.)]. Cambridge University Press, Cambridge, 2007), methane scores 25 (meaning that one tonne of methane will cause the same amount of warming as 25 tonnes of CO₂), nitrous oxide is 298 and some fluorinated gases score more than 10,000.

As used herein, the term ‘U-value’ means the sum of the thermal resistances of the layers that make up an entire building element—for example, a roof, wall or floor. It also includes adjustments for any fixings or air gaps. A U-value value shows, in units of W/m₂K, the ability of an element to transmit heat from a warm space to a cold space in a building, and vice versa. The lower the U-value, the better insulating the building element.

As used herein the term ‘bio-resin’ of ‘bio-based resin’ refers to a resin that derives some or all of its constituents from biological sources. These biological sources are generally plant-based, usually corn or soybean by-products from bio-diesel fuel refinement. Other examples include sugar cane, sugar beets, potatoes, lignocellulose, whey and algae. Bio-resins are generally biodegradable as defined elsewhere herein.

### DETAILED DESCRIPTION

This invention generally relates to a modular demountable construction system that can be used to build structures such as homes, offices, outbuildings, industrial units and shops. In particular, the invention relates to a system that comprises a relatively small number of building blocks, or modules, or cassettes, that may be suitably arranged and joined to form the required walls, floors and roofs of a building structure.

The joints between cassettes are suitably interlocking and sufficiently robust to hold the cassettes together and maintain the structure of which they are a part. The cassettes are also readily, or easily, demountable, meaning that one or more cassettes can be removed from the building structure with no, or minimal, disruption to neighbouring cassettes or to the remainder of the building. The demountable nature of the joints of the cassettes, combined with the modularity of the system, means the removed cassettes can be reinstalled, or re-used elsewhere in the same building or in another building, possibly with the addition of further cassettes to provide a means of ready deconstruction, disassembly, renovation, and/or extension of buildings.

The advantages of the demountable nature of the system may therefore be summarised as, at least, enabling:
non-destructive alterations during the lifetime of the building;
providing affordable layout flexibility according to changing user needs;
the recycling and reuse of components;
a circular economy of components to minimise waste.

The cassettes of the system are designed to be assembled off-site (prefabricated) to enable production scaling, better quality control and increases in efficiency, both in terms of cost and in terms of energy use and environmental impact of production. In embodiments, the cassettes may be provided in panelised form or assembled off site into volumetric elements to allow for the use of the system within a wide range of site constraints including hard to access, or ‘off-grid’, sites. In some cases, one or more cassettes can be assembled into larger modules prior to installation in the building structure.

Furthermore, the modules and joints between modules are made almost entirely from plant-based materials, avoiding petroleum-derived, or otherwise non- or poorly biodegradable materials, or materials that have a high social or environmental impact.

In addition, in embodiments of the system, the cassettes incorporated within the building envelope materials which have high hygrothermal performance, which can passively regulate indoor humidity levels to create a healthy living environment, reducing the need for mechanical ventilation (or energy inefficiency caused by users opening windows etc.). This, along with the joints between cassettes being effectively air-tight, means the system can achieve very high levels of thermal performance with the option of Passivhaus® standard.

The use of substantially biodegradable materials, alongside the ability to readily deconstruct, disassemble, renovate, and/or extend buildings constructed using the system of the present invention offers significant advantages over prior art systems, at least in terms of sustainability, green design, and the carbon footprint throughout the entire lifecycle of the system.

Various features, objects and advantages of the invention will be made apparent from the following description taken together with the drawings.

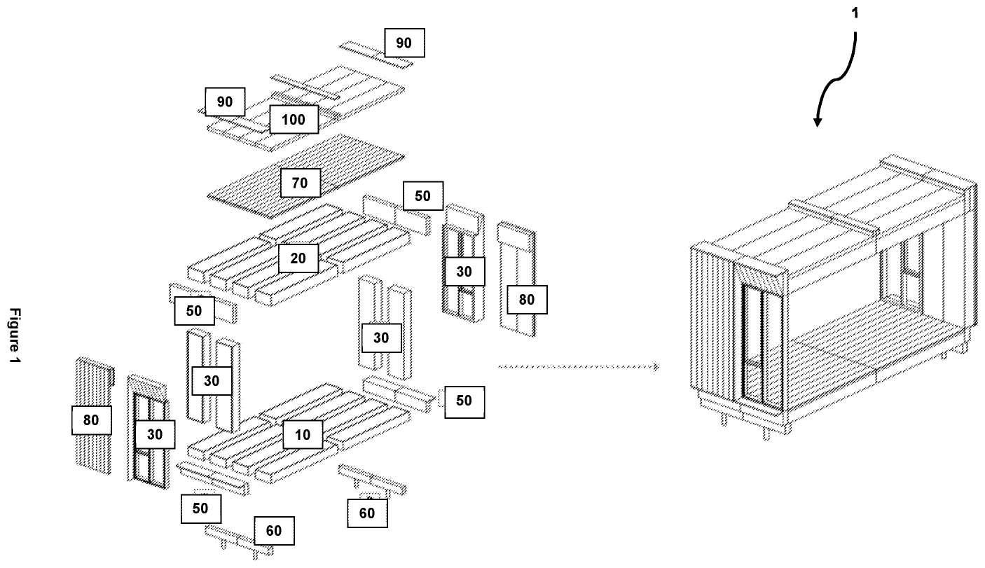

FIG. 1 shows an overview of the modular system in accordance with an embodiment of the present invention. Modular cassettes (for example, floor cassettes 10 and roof cassettes 20) are arranged in generally horizontal planar sections forming respectively the floor and the roof of the building structure 1. The horizontal planar sections are stacked vertically, overlying, in floor levels, separated and supported by further vertically mounted modular cassettes (for example, wall cassettes 30) that form the walls of the building structure.

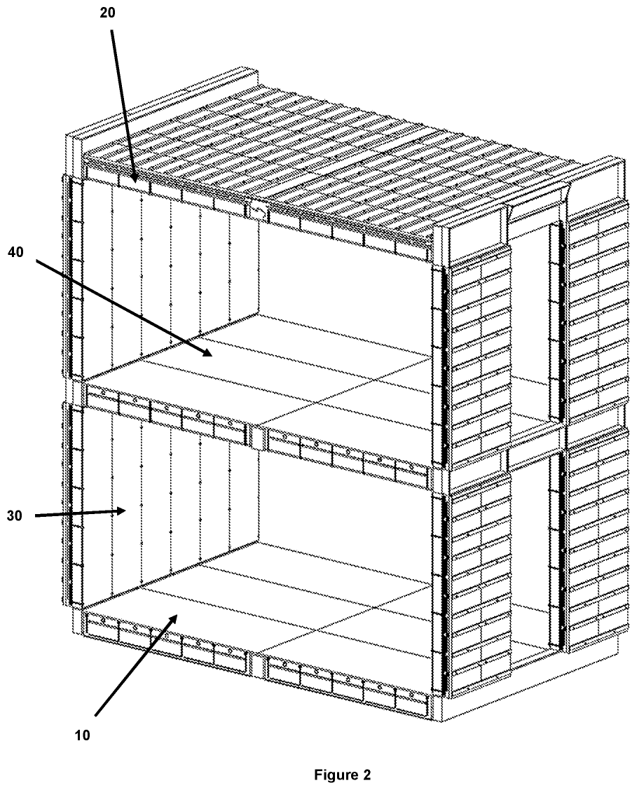

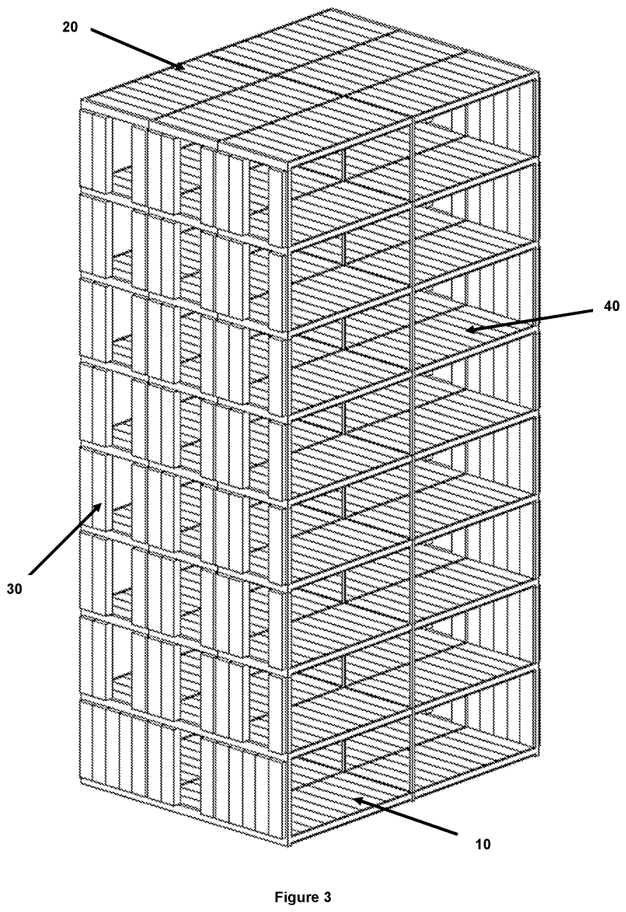

As best shown in FIGS. 2 and 3, between the horizontal planar sections forming respectively the floor and the roof of the building structure 1, in embodiments, there may be present modular cassettes (intermediate floor cassettes 40) arranged in generally horizontal planar sections that form intermediate floors between the roof and floor.

In embodiments, each cassette, whether arranged vertically or horizontally in use, is joined at each end to one or more other cassettes. Optionally, and as shown in FIG. 1, the cassettes may be joined via junction cassettes 50.

In embodiments, the building structure 1 may be supported on any suitable foundation or piled support. In the embodiment shown in FIG. 1 the structure is suspended on ring beam and screw piles 60. Use of screw piling can reduce ground works and the environmental impact relating to the use of concrete in slab foundations.

The general structure may be provided with flooring 70, additional insulation (not shown) and cladding 80 on the walls and additional copings 90 or cladding 100 on the roof for weatherproofing and/or decoration.

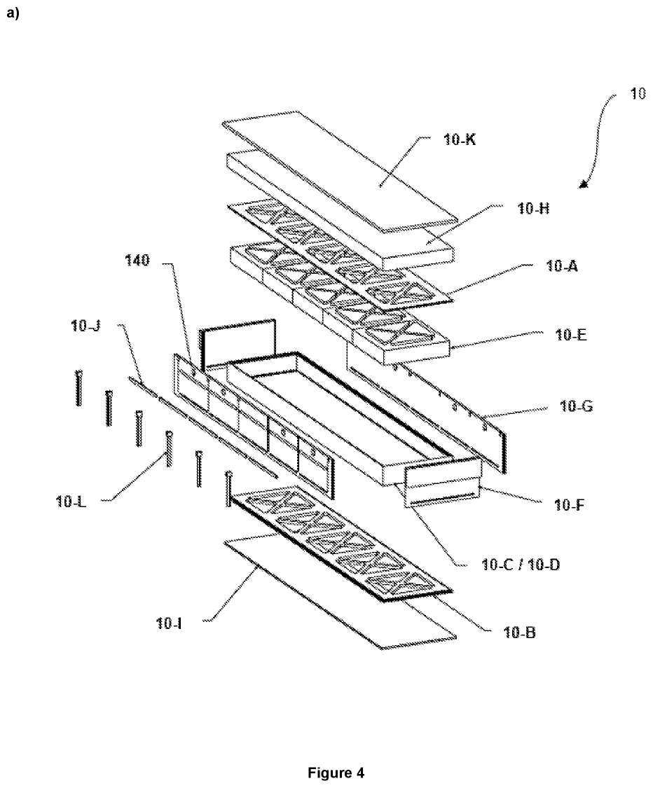

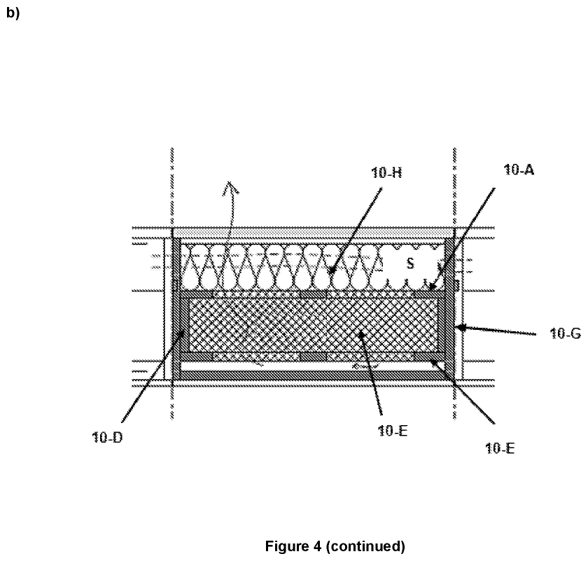

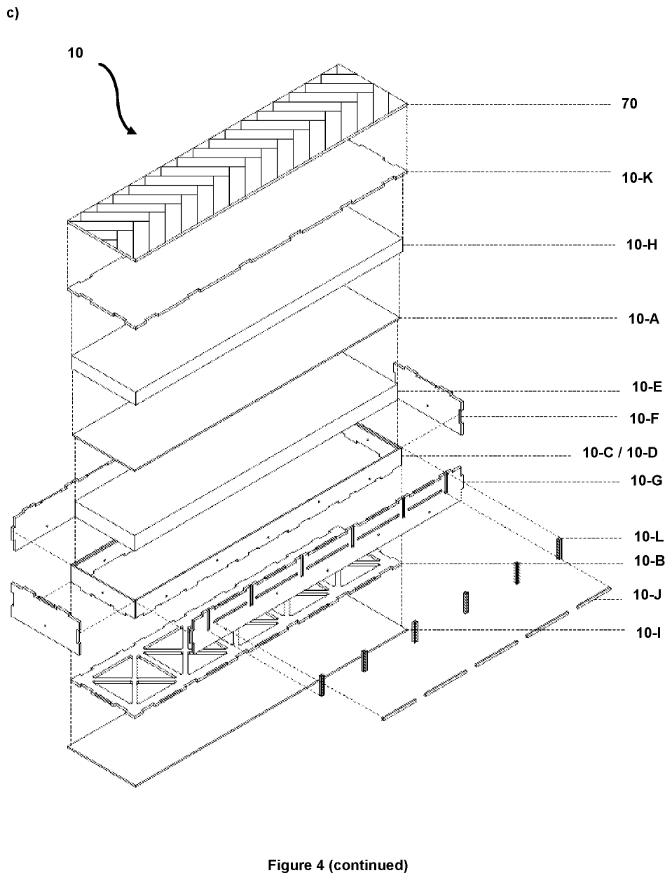

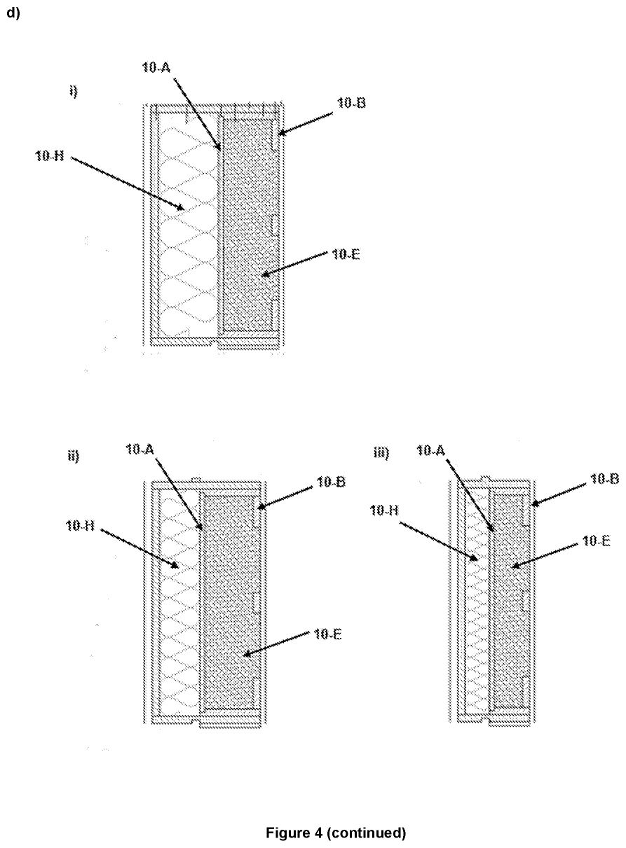

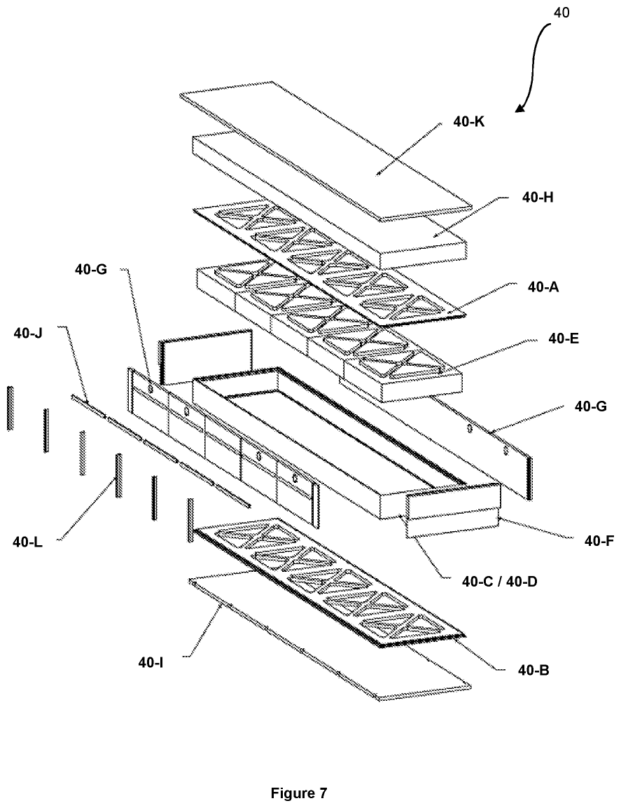

As best seen in any of FIGS. 4 to 7, each of the main structural cassette types 10, 20, 30, 40 shares a number of features of relevance to the present invention. Any shared features are described below in reference to ‘a cassette’. While there may be minor variations in how each feature is applied to a given cassette, which is discussed in more detail below, any references to ‘a cassette’ in the following description is intended to refer to any cassette type as herein described including wall, floor, intermediate floor and roof cassettes respectively, unless otherwise specified.

In embodiments, a cassette 10, 20, 30, 40 in accordance with the present invention has a generally box-like shape. Suitably a ‘box-like shape’ may be defined as a structure having walls, a top and a bottom that when assembled enclose or substantially surround an interior volume.

Suitably the cassette has a regular or non-regular geometric shape in plan view (i.e. along a dimension defined between the top and bottom of the cassette, elsewhere herein defined as the height). Suitably, the geometric shape may be irregular, i.e. a single or multi-sided shape having no regular shape; or regular. Suitably the shape may have one, two, three, four, five, six, seven, eight, nine, ten, eleven, twelve or more sides. In embodiments, the regular shape may be a circle, an oval, a triangle, a square, a rectangle, a pentagon, or a hexagon, Suitably the cassette has a rectangular box type shape in plan view

The cassette 10, 20, 30, 40 may be of any suitable dimensions. Suitably, the cassette has a length that is longer than a width, and/or a width that is longer than its height. Suitably, the length of the cassette is approximately 2.5 m to 3.5 m, suitably approximately 3 m. Suitably, the width of the cassette is 500 mm to 700 mm, suitably approximately 600 mm. Suitably, the height of the cassette is 250 mm to 350 mm, suitably approximately 300 mm excluding external finishes/finishing boards.

In embodiments, the cassette 10, 20, 30, 40 comprises an inner cassette 120 and an outer cassette 140, the outer cassette fully, or at least substantially, surrounding, and in contacting relation with, the exterior of the inner cassette. The outer cassette may be bonded, doweled, screwed, nailed and/or otherwise affixed to, the inner cassette. The use of an outer cassette 140 surrounding and affixed to an inner cassette 120 provides greater load bearing capacity of a cassette 10, 20, 30, 40.

In embodiments, the inner cassette 120 comprises and/or contains or is filled with breathable insulation, suitably, rigid breathable bio-aggregate insulation. Each cassette 10, 20, 30, 40 optionally comprises further breathable insulation 180, suitably natural fibre insulation or rigid insulation within, or attached to, the outer cassette structure. In embodiments, each cassette 10, 20, 30, 40 may also comprise external boarding/cladding 80, 90, 100, and frameworks to which this can be affixed to provide surface finishing or protection of the inner components of the cassette from the environment or physical damage and allow free passage of air to circulate as in a typical ventilated rain screen cladding system.

With reference to the embodiments shown in FIGS. 4 to 7, the inner cassette 120 has the general structure of a box, suitably a rectangular box, comprising: a planar lid (10-A, 20-A, 30-A, 40-A); a planar base (10-B, 20-B, 30-B, 40-B); two opposing, generally parallel, end panels (10-C, 20-C, 30-C, 40-C; and two opposing, generally parallel, side panels (10-D, 20-D, 30-D, 40-D). The side panels and the end panels separate the generally parallel lid and base to define an interior volume of the inner cassette.

It should be noted that while the terms ‘base’ and ‘lid’ are used this terminology relates only to the orientation of the features within the cassette structure once assembled, i.e. the base is the face of the inner cassette 120 at, or approaching, an outer edge of the cassette 10, 20, 30, 40, the lid being the face of the inner cassette 120 at, or approaching, a mid-line of the cassette 10, 20, 30, 40, approximately mid-way up the height of the side/end panels of the outer cassette 140. In isolation, the inner cassette 120 is suitably symmetrical and therefore the lid and the base may be interchangeable until the outer cassette 140 is affixed to the inner cassette 120.

The cassette 10, 20, 30, 40, depending on the type and requirements of installation, may be installed with the base 10-B, 20-B, 30-B, 40-B of the inner cassette 120 oriented upward or downward or side-ways facing, either facing the interior or exterior of the structure. The same applies for the lid 10-A, 20-A, 30-A, 40-A.

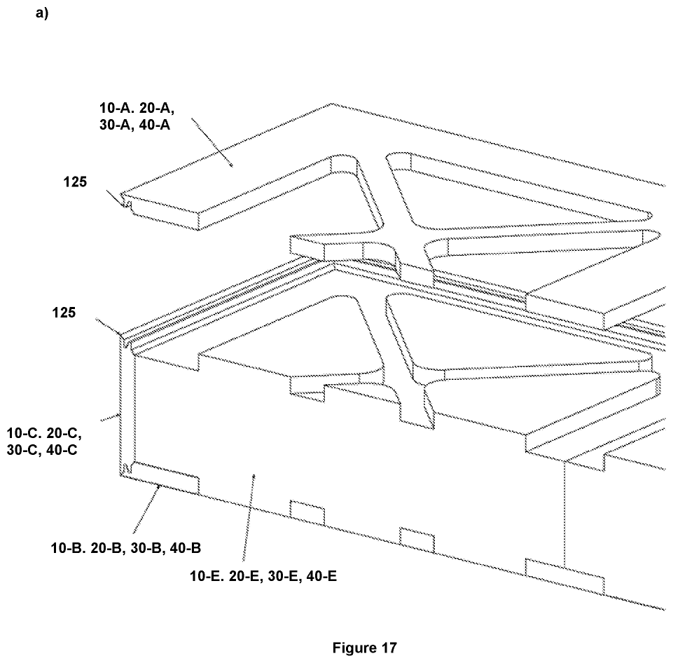

In embodiments, the lid 10-A, 20-A, 30-A, 40-A and the base 10-B, 20-B, 30-B, 40-B of the inner cassette 120 are joined, suitably permanently joined, to the end panels 10-C, 20-C, 30-C, 40-C and the side panels 10-D, 20-D, 30-D, 40-D with suitable joints, for example, lock mitre joints (FIG. 17). Lock mitre joints may be particularly suited to this purpose and offer a robust joint that adds significant structural rigidity to the inner cassette, and the cassette as a whole.

In embodiments, the base 10-B, 20-B, 30-B, 40-B and/or the lid 10-A, 20-A, 30-A, 40-A of the inner cassette 120 may be solid (i.e. have no apertures of holes) as shown in FIG. 4c for example. In alternative embodiments, the lid 10-A, 20-A, 30-A, 40-A and/or the base 10-B, 20-B, 30-B, 40-B of the inner cassette 120 comprises holes or apertures or other means to allow free passage of air through from the exterior to the interior of the inner cassette 120, as shown in FIG. 4a for example. Suitably, both the lid 10-A, 20-A, 30-A, 40-A and the base comprise holes or apertures. Alternatively, only the base comprises holes or apertures. In alternative embodiments, the lid 10-A, 20-A, 30-A, 40-A and/or base 10-B, 20-B, 30-B, 40-B may be made from vapour permeable board in which case holes or apertures are not required to allow free passage of air through from the exterior to the interior of the inner cassette 120.

In embodiments, the interior volume of the inner cassette 120 is at least partially filled with insulation 10-E, 20-E, 30-E, 40-E. Suitably, the insulation 10-E, 20-E, 30-E, 40-E covers at least any apertures in the base 10-B, 20-B, 30-B, 40-B and/or lid 10-A, 20-A, 30-A, 40-A. Preferably, the insulation 10-E, 20-E, 30-E, 40-E extends across the entire length and width of the inner cassette interior. Suitably, the minimum thickness of the insulation 10-E, 20-E, 30-E, 40-E perpendicular to the base is approximately 30-70% of the height of the inner cassette 120. Suitably, the insulation 10-E, 20-E, 30-E, 40-E has a thickness such that it fills the interior of the inner cassette 120. In embodiments, the insulation 10-E, 20-E, 30-E, 40-E is shaped or cast so that it substantially, if not completely, fills the interior volume of the inner cassette 120. Suitably, the insulation 10-E, 20-E, 30-E, 40-E is moulded or cast such that it fills with interior of the inner cassette 120 and further extends into, suitably filling, the apertures in the base 10-B, 20-B, 30-B, 40-B and/or the lid 10-A, 20-A, 30-A, 40-A of the inner cassette 120, when present. In embodiments where the insulation 10-E, 20-E, 30-E, 40-E extends into the apertures in the lid 10-A, 20-A, 30-A, 40-A and base 10-B, 20-B, 30-B, 40-B of the inner cassette 120, this allows for maximum thickness of insulation 10-E, 20-E, 30-E, 40-E but also acts to secure the insulation 10-E, 20-E, 30-E, 40-E in the inner cassette 120 to inhibit movement of the insulation 10-E, 20-E, 30-E, 40-E and thereby reduce the propensity for damage to the insulation 10-E, 20-E, 30-E, 40-E or the inner cassette 120 during production, transport to site, or installation.

A particularly advantageous aspect of the invention is that the arrangement of the insulation 10-E, 20-E, 30-E, 40-E within the inner cassette 120 allows the breathable bio-aggregate blocks to regulate indoor humidity levels, thereby increasing thermal comfort and reducing the need for mechanical ventilation within buildings. The hygrothermal properties of a building are becoming ever more important. Referring to the movement of heat and moisture through buildings, it is known that repeated wetting, drying, freezing and thawing of the fabric of a building can cause problems such as damp, condensation, mould growth and loss of thermal performance, and may even result in premature failure. By enhancing the hygrothermal performance of building assemblies, the risks of problems associated with these mechanisms can be avoided, or at least minimised. By providing means of controlling and balancing the water vapour in the air within a building, problems such as condensation, moisture entrapment, fungal growth, material degradation, and so on can be reduced and the correct balance between heat and moisture can be achieved.

Furthermore, the rigid support of the inner cassette structure, for example through the use of lock mitre joints in its construction, and the integrated, enclosed insulation 10-E, 20-E, 30-E, 40-E act to increase the structural capacity of the cassette as a whole.

Protection of the insultation 10-E, 20-E, 30-E, 40-E by the inner cassette structure also permits the use of relatively low density (hence lower thermal conductivity) and relatively fragile bio-aggregate blocks or infill thereby protecting them from damage during construction.

The insulation 10-E, 20-E, 30-E, 40-E provides a thermal barrier by reducing or eliminating air flow through the cassette 10, 20, 30, 40. Suitably, the insulation 10-E, 20-E, 30-E, 40-E has a thickness chosen to achieve the desired thermal barrier properties for the inner cassette 120, and the modular cassette 10, 20, 30, 40 as a whole.

Suitably, the insulation 10-E, 20-E, 30-E, 40-E is breathable (i.e. allows for the passage of water vapour but not air). Suitably the insulation 10-E, 20-E, 30-E, 40-E has good hygrothermic properties. In preferred embodiments, the insulation 10-E, 20-E, 30-E, 40-E is formed of a suitable bio-aggregate, such as hemp-lime or any other plant based rigid insulation of suitable thickness. A particularly preferred bio-aggregate insulation is described in the co-pending PCT application no. PCT/GB2021/051962, the contents of which are incorporated herein by reference.

In embodiments, the insulation 10-E, 20-E, 30-E, 40-E is provided in the form of one or more insulation blocks. The use of multiple insulation blocks provides benefits in terms of ease of manufacture of the smaller individual blocks due the reduced size and weight. It also means that individual smaller blocks can be replaced if damaged prior to or after installation thereby reducing potential waste. In alternative embodiments, the insulation 10-E, 20-E, 30-E, 40-E is provided as a single or larger infill block. Suitably, single or larger insulation blocks are formed by casting or moulding directly into the carcass (base 10-B, 20-B, 30-B, 40-B plus sides 10-D, 20-D, 30-D, 40-D and ends 10-C, 20-C, 30-C, 40-C) of the inner cassette 120. Such an approach can beneficially result in eliminating air gaps in the structure that may otherwise reduce the air tightness of the cassette or provide a thermal bridge. Casting in situ also allows the insulation to fill any hole or aperture in the base 10-B, 20-B, 30-B, 40-B of the inner cassette 120.

To achieve the beneficial hydrothermal properties, the insulation in the inner cassette must be in contact with the air/moisture exterior to the inner cassette, and there is suitably a relatively free passage of movement of air/moisture between the insulation in the interior of the inner cassette and the air exterior to the inner cassette. Such a free passage of movement of air/moisture may be achieved in any appropriate manner. Suitably, the inner cassette has holes or apertures on at least one surface that exposes the insulation 10-E, 20-E, 30-E, 40-E to the exterior environment, Alternatively, in addition, or instead, the inner cassette may have at least one surface that is vapour permeable. Suitably, the surface of the inner cassette that has holes or apertures, or the surface of the inner cassette that is vapour permeable is the top or bottom of the inner cassette that faces the interior of the building.

The holes or apertures in the lid 10-A, 20-A, 30-A, 40-A and/or the base 10-B, 20-B, 30-B, 40-B of the inner cassette 120, when present, may be the same or different. Suitably, the holes or apertures are sized to provide the maximal open area whilst retaining the required structural integrity to the lid 10-A, 20-A, 30-A, 40-A and/or base 10-B, 20-B, 30-B, 40-B for assembly and installation. A maximal open area provides the greatest surface area for contact of the air with the insulation 10-E, 20-E, 30-E, 40-E contained therein. In the embodiments shown best in FIGS. 4a, 6a and 7, the holes are repeating squares that extend substantially across the width of the lid 10-A, 20-A, 30-A, 40-A and/or base 10-B, 20-B, 30-B, 40-B, the squares having supports running diagonally between opposing corners. It is to be appreciated that any shape or size of aperture of hole is envisaged that provides exposure of a suitable surface area of the insulation to the air, while suitably retaining the insulation within the inner cassette, and providing sufficient structural rigidity.

One particularly suitable embodiment of the inner cassette 120 comprises a base 10-B, 20-B, 30-B, 40-B with holes or apertures filled with bio-aggregate insulation 10-E, 20-E, 30-E, 40-E and closed with a lid 10-A, 20-A, 30-A, 40-A formed of vapour permeable board (see for example, FIGS. 4c and 4d). In such embodiments, the vapour permeable board may of any suitable vapour permeability, suitably, the vapour permeable board has a vapour permeability of between 0.5 and 1.0 MNs/g, suitably, 0.5 to 0.8 MNs/g, suitably approximately or exactly 0.66 MNs/g.

The outer cassette 140 has the general structure of a box open on both largest faces. The outer cassette 140 has walls that surround the inner cassette 120, suitably extending circumferentially around, and generally in continuous contacting relation with, the exterior of the side panels 10-D, 20-D, 30-D, 40-D and the end panels 10-C, 20-C, 30-C, 40-C of the inner cassette 120. The outer cassette 140 comprises at least one, suitably two opposing, generally parallel, end panels 10-F, 20-F, 30-F, 40-F and two opposing, generally parallel, side panels 10-G, 20-G, 30-G, 40-G. Suitably, the side panels 10-G, 20-G, 30-G, 40-G of the outer cassette 140 are affixed, or bonded, to the exterior side of the side panels 10-D, 20-D, 30-D, 40-D of the inner cassette 120; and end panel(s) 10-G, 20-G, 30-G, 40-G of the outer cassette 140 are affixed or bonded to the exterior side of the end panel(s) 10-C, 20-C, 30-C, 40-C of the inner cassette 120. Suitably, the side panels 10-G, 20-G, 30-G, 40-G and the end panel(s) 10-F, 20-F, 30-F, 40-F are joined at the vertices of the outer cassette 140 with a suitable joint, for example a lock-mitre joint to provide a secure and robust structure.

The double layer arrangement of the inner cassette 120 and the outer cassette 140 increases the structural capacity of the overall cassette structure.

In embodiments, the end panel(s) 10-F, 20-F, 30-F, 40-F and the side panels 10-G, 20-G, 30-G, 40-G of the outer cassette 140 extend upwardly from the level of the lid 10-A, 20-A, 30-A, 40-A of the inner cassette 120 beyond the top of the corresponding end panels 10-C, 20-C, 30-C, 40-C and side panels 10-D, 20-D, 30-D, 40-D of the inner cassette 120. This additional height of the outer cassette 140 adds structural rigidity to the overall cassette structure. This is important for all cassettes and particularly important for those cassettes that are intended to be positioned horizontally, spanning supports positioned at each end of a cassette where the side panels of the outer and inner cassettes act as webs to resist bending of the cassette under load.

The extension of the outer cassette 140 beyond the inner cassette 120 also provides fora space or void formed adjacent the lid 10-A, 20-A, 30-A, 40-A of the inner cassette 120 within the open box structure of the outer cassette 140. This void or space may be filled with further insulation 10-H, 20-H, 30-H, 40-H, such as flexible natural fibre insulation or rigid insulation. In embodiments, the outer cassette 140 is closed by a top 10-K, 20-K, 30-K, 40-K.

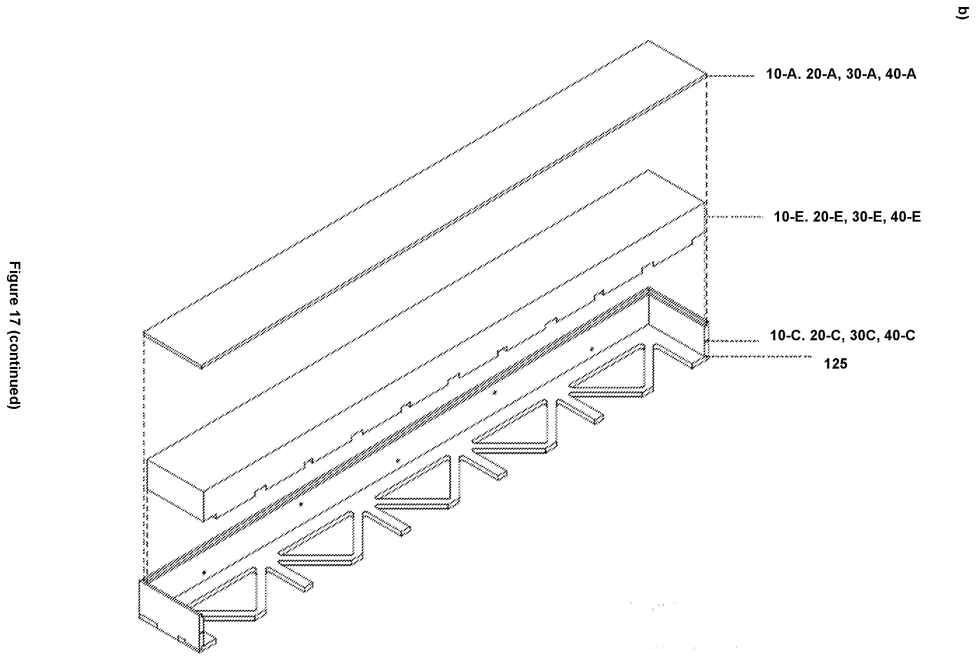

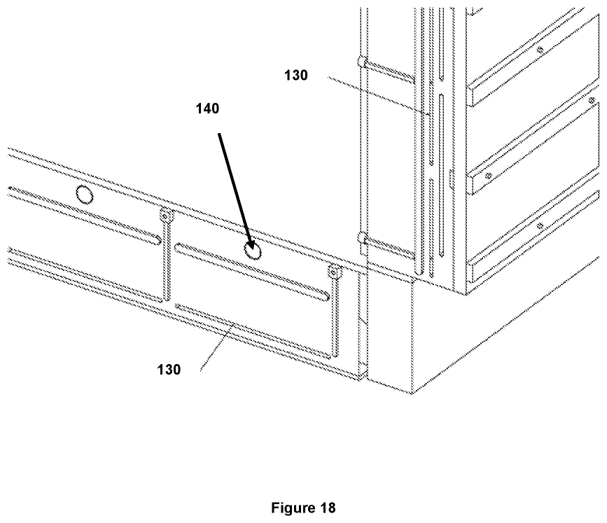

As best shown in FIG. 18a, the portions of the outer cassette end panels and side panels that extend beyond the height of the inner cassette 120 may comprise perforations such as holes or slots. Suitably the perforations are one or more slots 130 that extend along the length of the panel. Suitably, there may be multiple layers of slots formed in the outer cassette end panels 10-F, 20-F, 30-F, 40-F and side panel(s) 10-G, 20-G, 30-G, 40-G. The slots 130 act to avoid thermal bridges by preventing heat being passed through the structure of the outer cassette 140 from one side of the cassette 10, 20, 30, 40 to the other. These slots also provide routes for lateral air movement between cassettes once installed to improve air circulation within the building structure 1 and/or prevent build-up of dangerous gases, such as xenon.

In embodiments of some cassettes, for example, ground floor cassettes 20, the side panel(s) 20-G and the end panels 20-F of the outer cassette extend below the base of the inner cassette 120 and slots 130 are provided in this region, below or to the underside of the inner cassette 120 to allow cross ventilation under the floor.

Holes 140 or routing for main services S such as electricity, gas and water may be pre-formed in the side or end panels of the inner cassette and/or the outer cassette and/or in the insulation blocks. These may be provided in the form of weakened ‘knock-out’ sections that may be provided closed yet can be readily opened during manufacture or on site as needed. This may be of particular utility in volumetric units where first fix, or second fix, services may be installed during off-site assembly of the cassettes.

Each face of the assembled cassette may be finished, or covered, with a variety of breathable board 10-I, 20-I, 30-I, 40-I, flooring 70, or weather-proofing materials such as cladding 80, 100 or roofing 110 depending on need. Suitably, these finishing layers are readily demountable to allow for easy access to the interior of the cassettes for demounting or removal thereof or replacement of the cladding.

The dimensions, and relative proportions of the cassettes, or the inner cassette or outer cassette can be chosen based on the intended use, and/or to achieve certain properties. One such property is thermal insulation as defined by a U-value. As seen in FIG. 4a, (i) is an ultra-low energy version of the floor panel with a thickness of the bio-aggregate insulation being around 150 mm and the natural fibre insulation also being around 150 mm; this panel has a calculated U-value of around 0.13; (ii) a low energy version of the floor panel with a thickness of the bio-aggregate insulation being around 150 mm and the natural fibre insulation also being around 100 mm; this panel has a calculated U-value of around 0.16; (iii) a slim version of the floor panel with a thickness of the bio-aggregate insulation being around 100 mm and the natural fibre insulation also being around 60 mm; this panel has a calculated U-value of around 0.25.

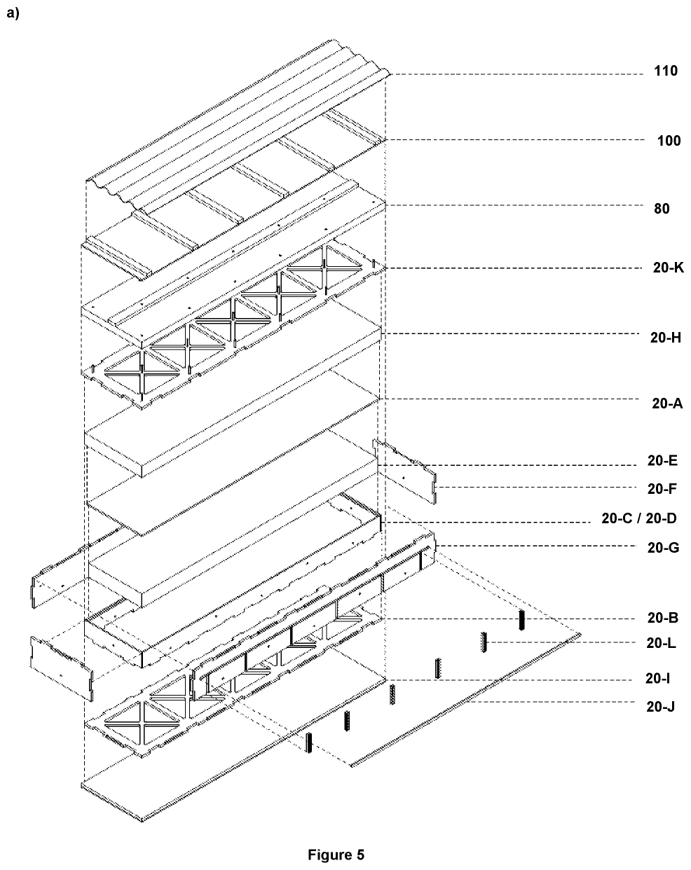

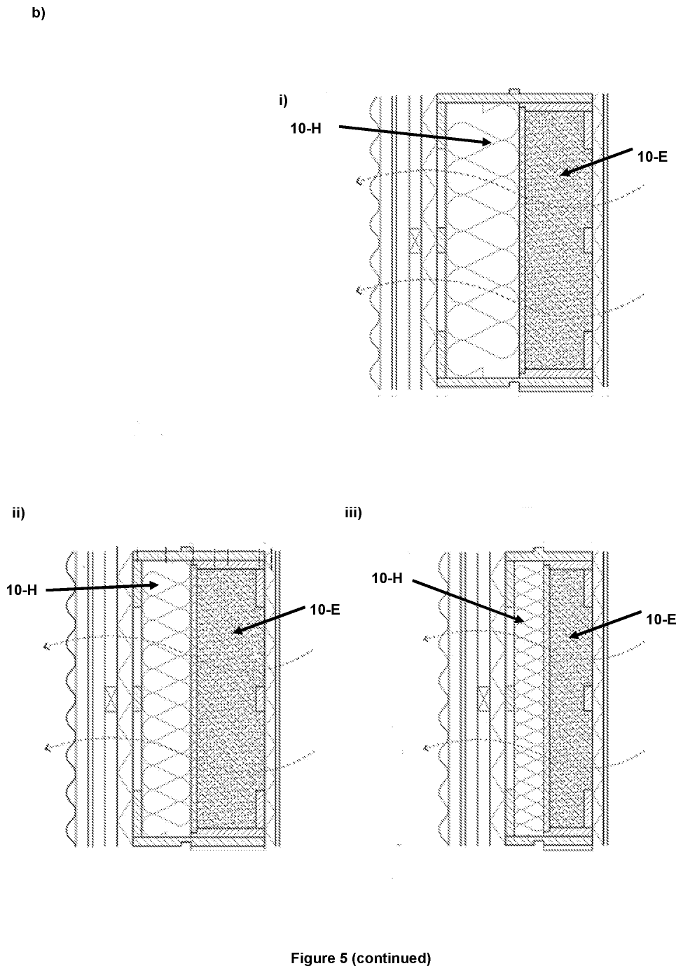

FIG. 5b shows a similar arrangement of ultra-low energy, low energy and slim panels with the additional copings, cladding and roofing required for a roof panel 20.

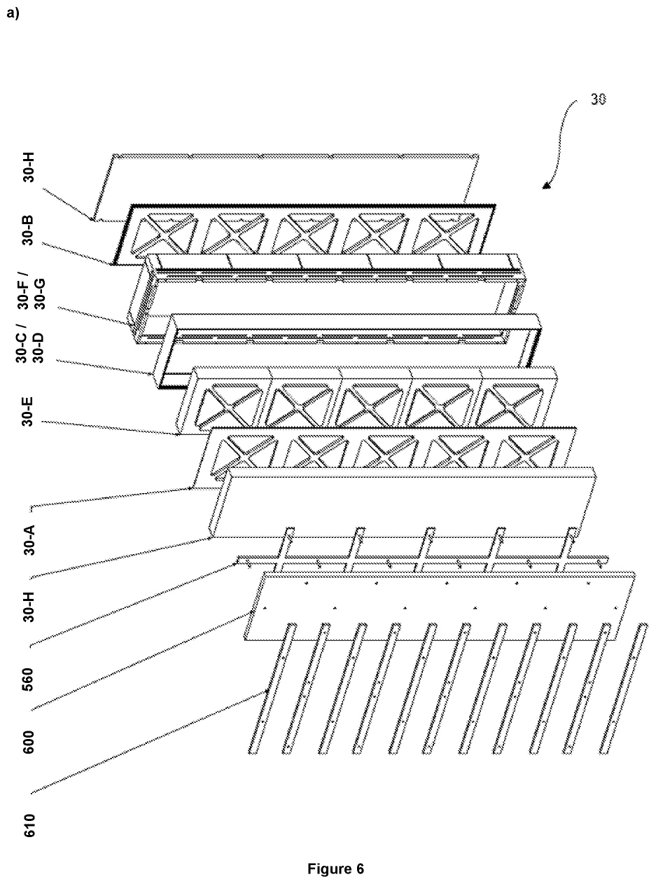

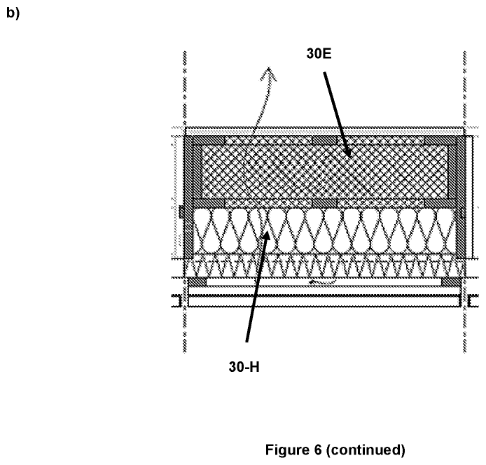

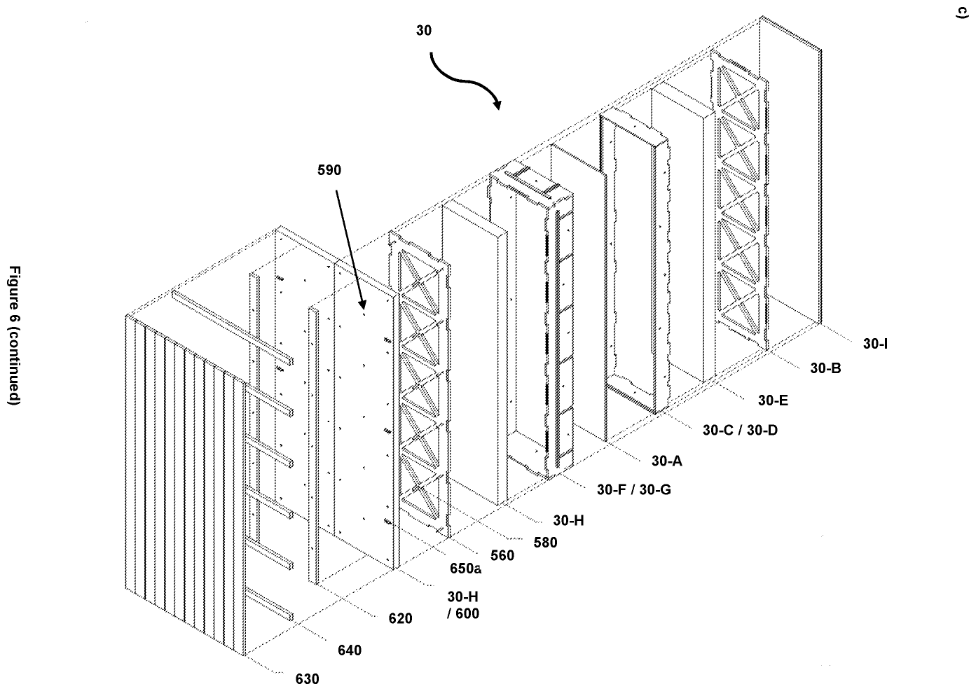

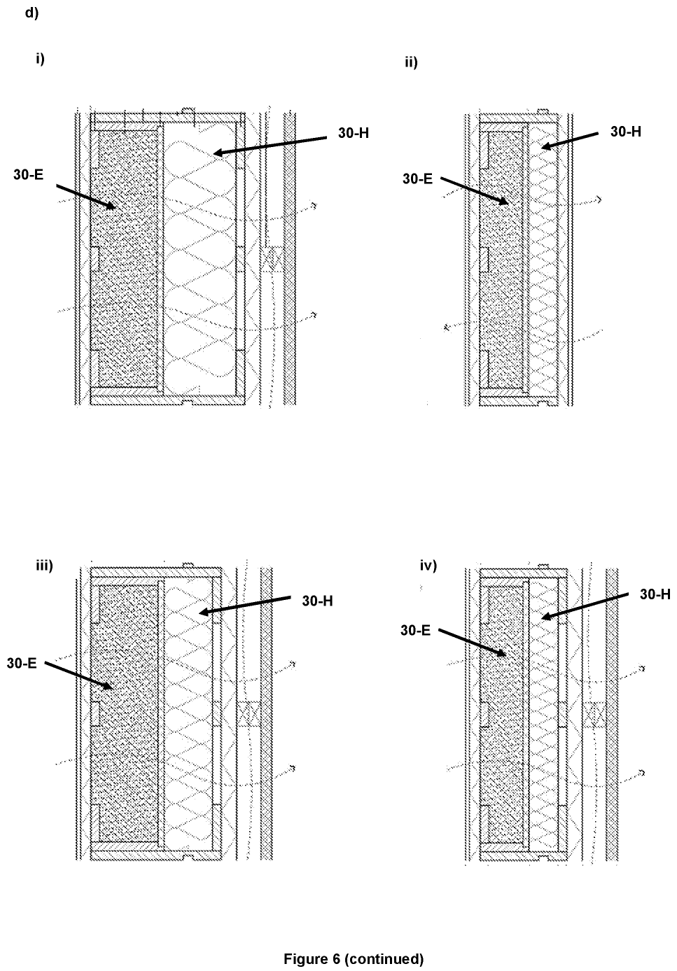

FIG. 6d again shows a similar arrangement of ultra-low energy, low energy and slim panels in (i), (iii) and (iv) respectively. FIG. 6d (ii) also shows an internal variant of the wall panel that dispenses with a top panel on the outer cassette as the need for support on a face of a wall panel is reduced.

The main components of the cassette 10, 20, 30, 40, in particular the inner cassette 120 and the outer cassette 140 may be formed of any suitable material. In embodiments, the inner cassette 120 and/or the outer cassette 140 are formed of sustainable or biodegradable materials such as wood, or wood derivatives. Suitably, the inner cassette 120 and/or the outer cassette 140 are formed only of, or substantially of, sustainable or biodegradable materials such as wood, or wood derivatives. Suitably the inner cassette 120 and the outer cassette 140 may be formed of engineered or composite sheet material, such as ply or oriented strand board (OSB). These materials are commonly available, relatively inexpensive and well-known in the construction industry. These materials also have good structural rigidity with low weight. Engineered wood sheet materials tend to come in a maximum standard length of 3 metres. Therefore, the components of the cassettes 10, 20, 30, 40 may suitable be designed to be cut from a standard sheet, i.e. be no more than 3 m in length, thereby minimising material costs and facilitating manufacture. Cutting of the board may be by any suitable means, for example using a band saw and routers. Suitably, cutting is performed by CNC (computer numerical control) techniques.

To achieve enhanced stiffness in a building 1 made using the system of the invention, the cassettes 10, 20, 30, 40 may suitably be interlinked, inter-engaged and/or fixed together. Any means of inter-engagement or fixing between one or more cassettes is contemplated. Suitably, inter-engagement may be by demountable joints that hold the cassettes together. Such demountable joints may require no additional independent fixings, such as screws, nails or non-wooden brackets.

The cassettes 10, 20, 30, 40 may further comprise a means of alignment to assist in construction. The means of alignment are suitably demountable and require no or minimal additional fixings. Where additional fixings are required the fixings are suitably removeable from within the interior or exterior of cassette, optionally following removal of readily demountable outer facings and insulation, meaning that they may be removed with minimal or no disturbance of the building structure.

A particularly advantageous feature of the present invention is the reliance on traditional woodworking joints to join and fix the cassettes to each other. For centuries joiners have been developing means of joining wood together reliant only on the shape of the wood pieces, and without the need for independent fixings such as screws, nails, or glue. These joints are well-tested, robust and use nothing more than wood which is inherently biodegradable. The lack of independent fixings also makes the joints potentially easily and readily demountable, i.e. separated. Any suitable demountable joint is contemplated for use in the invention. Certain joints that have been shown to work effectively are described in detail below.

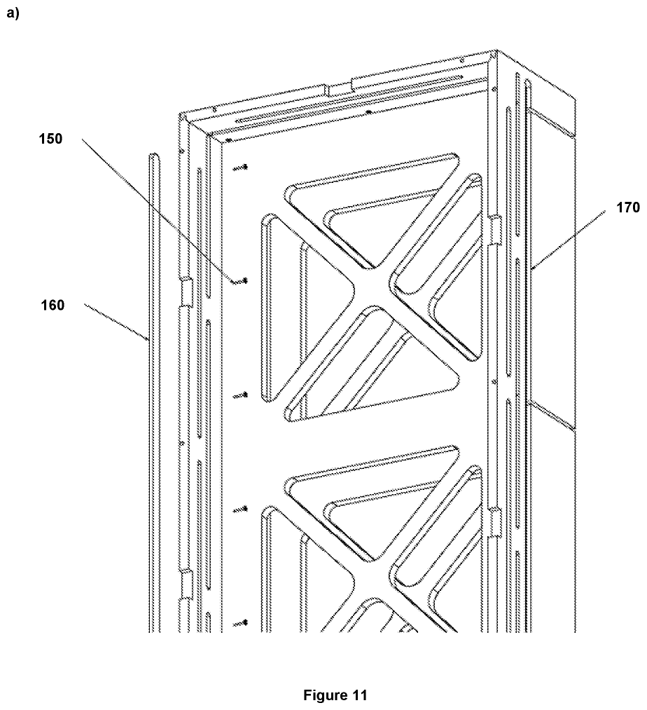

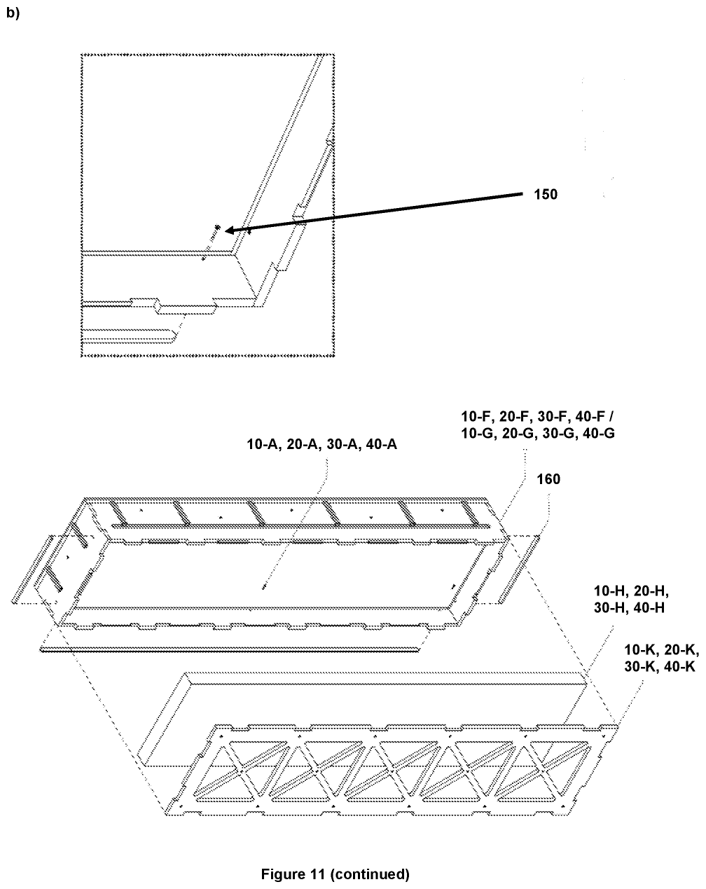

A first embodiment of a demountable means of alignment of a cassette in accordance with the present invention is best seen in FIGS. 11a and 11 b. In this embodiment, the outer cassette end panel(s) 10-F, 20-F, 30-F, 40-F and/or side panels 10-G, 20-G, 30-G, 40-G comprise means for aligning one cassette with at least one adjacent or neighbouring cassette.

Suitably, removable tongue and groove (RT&G) may be used. These joints comprise one or more strips 10-J, 20-J, 30-J, 40-J, 160, or other suitable protrusions, are mounted on the exterior surface of one or more of the outer cassette side panels 10-G, 20-G, 30-G, 40-G and/or end panel(s) 10-F, 20-F, 30-F, 40-F. In the embodiment shown, the one or more strips 10-J, 20-J, 30-J, 40-J, 160 are mounted on the outer cassette panel such that they extend away from the surface of the outer cassette panel. Suitably, the strips 10-J, 20-J, 30-J, 40-J, 160 are dimensioned perpendicular to the plane of the outer cassette panel on which they mounted such that they extend sufficiently to enable them to align and engage with corresponding grooves 10-K, 20-K, 30-K, 40-K, 170 formed into the sides of another outer cassette 140 upon installation. This feature allows the cassettes to accurately align with each other (for ease and speed of assembly), whilst also forming a robust, airtight alignment.

The strips 10-J, 20-J, 30-J, 40-J, 160 are suitably fixed on 1, 2 or 3 sides of the outer cassette 140 by means of suitable fixings 150, such as countersunk torx® screws accessible from within the interior of the outer cassette 140 after removing the outermost panels and then the flexible natural fibre or rigid insulation 10-H, 20-H, 30-H, 40-H to leave the cassettes structure as shown in FIG. 11. This arrangement allows any of the cassettes to be demounted individually, thereby enabling future alterations or modifications and a circular economy of recycled components.

To provide further structural rigidity to the building structure 1, the cassettes 10, 20, 30, 40 may also, or alternatively, be fixed or locked together using peg or spline joints.

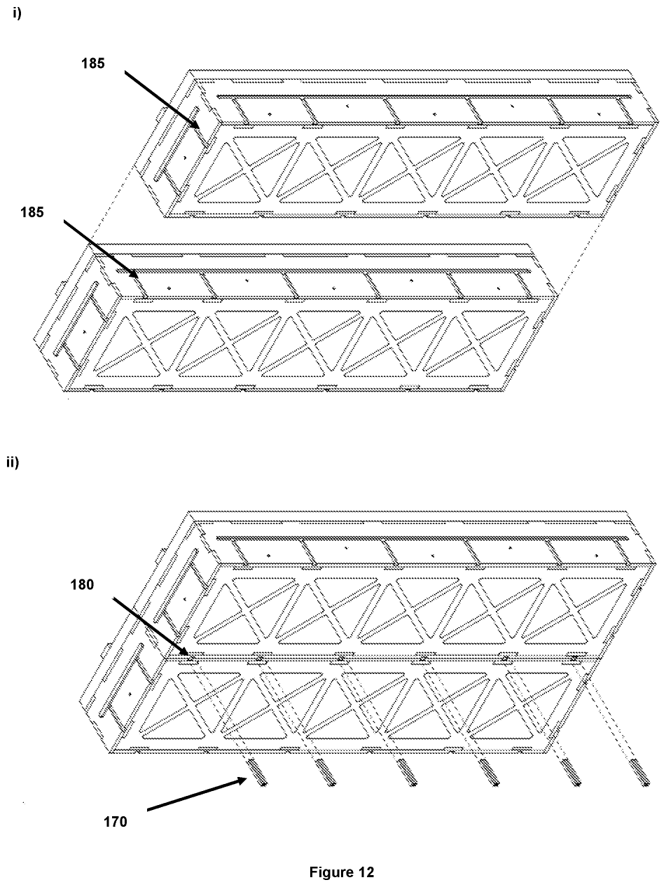

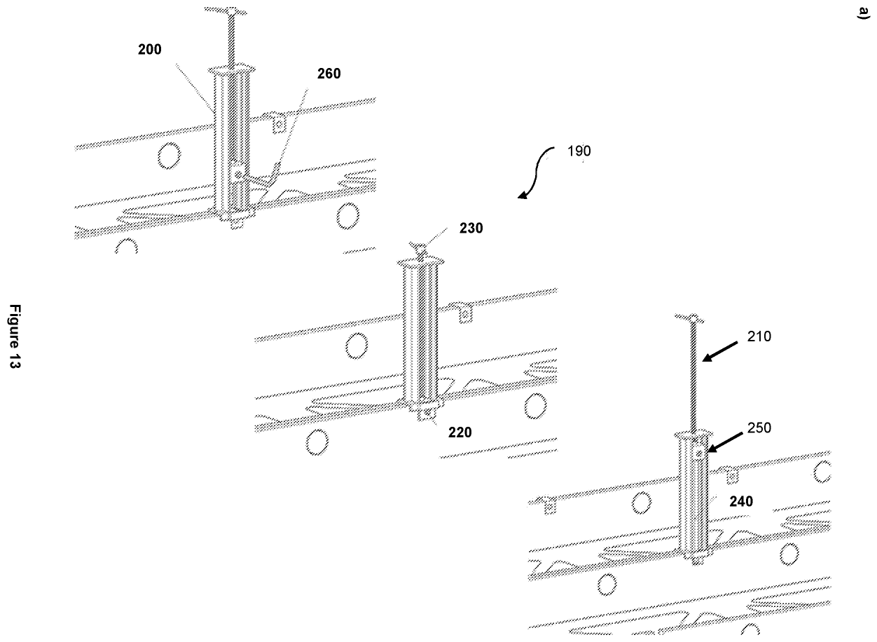

As seen in FIG. 12, although applicable to all cassette types, once the cassettes are installed and generally aligned (suitably using the RT&G described above) such that at least one side or end abut each other, one or more pegs or splines 10-L, 20-L, 30-L, 40-L, 170 may be inserted into one or more grooves or slots 180 formed by aligning open channels 10-M, 20-M, 30-M, 40-M, 185 formed in each of the outer cassette of two or more adjacent cassettes 10, 20, 30, 40. The open channels 10-M, 20-M, 30-M, 40-M, 185, and therefore also the grooves 180 formed when two cassettes are positioned adjacent to each other, are substantially straight and oriented substantially perpendicular to the base of the outer cassette 140. The open channels 10-M, 20-M, 30-M, 40-M, and therefore also the grooves 180 formed when two cassettes are positioned adjacent to each other, suitably extend substantially, if not completely, the full height of the outer cassette such that a peg or spline when inserted into the groove, can be accessed from each side of the cassette. Alternatively, the open channels 10-M, 20-M, 30-M, 40-M, and therefore also the grooves 180 formed when two cassettes are positioned adjacent to each other, suitably extend only partially the height of the outer cassette such that the structural rigidity of the cassette is not compromised.

In embodiments, the pegs or splines inserted into the aligned open channels or grooves may be a single unitary piece. In alternative embodiments, and as hereinbelow described, the pegs or splines may be formed of two or more pieces which may be inserted as one, and removed in a specified order, such as a central piece being removed before one or more outer pieces are removed. An arrangement where the peg or spline is formed of two or more pieces may facilitate removal of the peg or spline via a reduction in the friction of removing a single piece compared to the whole.

In embodiments, the open channel is suitably shaped such that its base, towards the interior of the outer cassette 140, is wider than the opening on the exterior surface of the outer cassette 140. In this way, a peg or spline inserted, or slid, into the open channel would be prevented from being pulled out in a direction perpendicular to the surface of the outer cassette 140. When two open channels 10-M, 20-M, 30-M, 40-M of this shape are aligned to form the groove or slot 180, insertion of a suitably shaped peg or spline 10-L, 20-L, 30-L, 40-L, 170 would fix the two cassettes together to form an air-tight joint and prevent the cassettes pulling apart. Such a joint is known in traditional woodworking techniques as a ‘bow-tie joint’ (also known as a butterfly or a dutch joint), as this accurately reflects the shape of the peg used in axial cross-section.

Suitably the peg or spline 10-L, 20-L, 30-L, 40-L, 170 is of a suitable length to not extend from either a top or a bottom surface of the cassette once inserted to allow ease of fixing of surface finishes to the cassette. Suitably, the peg or spline 10-L, 20-L, 30-L, 40-L, 170 is of a length to extend substantially, or fully, the length of the groove 180 to provide maximum strength of the joint. Suitably, the groove 180 in which the peg or spline 10-L, 20-L, 30-L, 40-L, 170 is inserted has a closed end, or a stop to prevent the peg being inserted too far or being knock through the groove 180.

In embodiments there are multiple spline joints provided on each side of the cassette 10, 20, 30, 40. Suitably there are 1, 2, 3, 4, 5, 6, 7, 8 or more spline joint provided on the sides of the cassette. Suitably there are 1, 2, 3, 4 spline joints provided on each end of the cassette. The choice of the number of spline joints is a balance between the need for structural rigidity and the ease of installing and demounting.

In combination with the RT&G described above, the ‘bow-tie’ spline junctions lock the cassette panels in the required alignment.

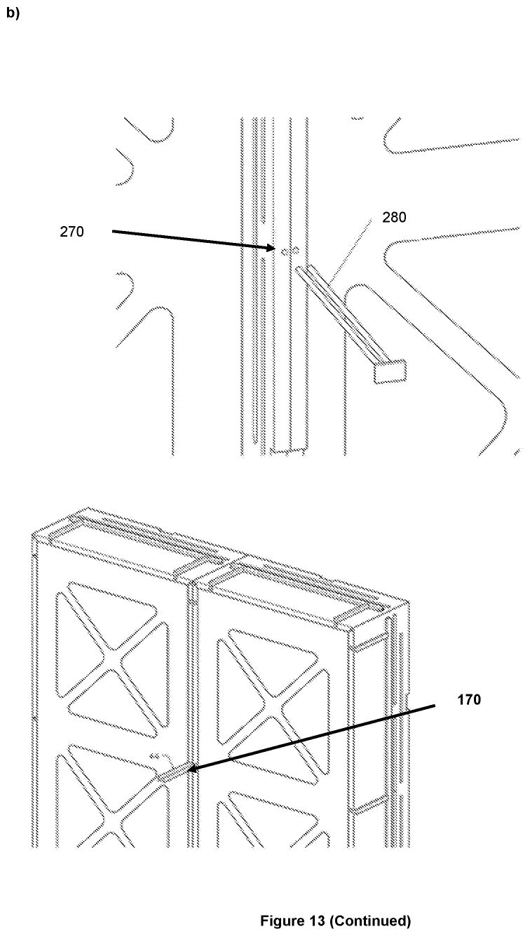

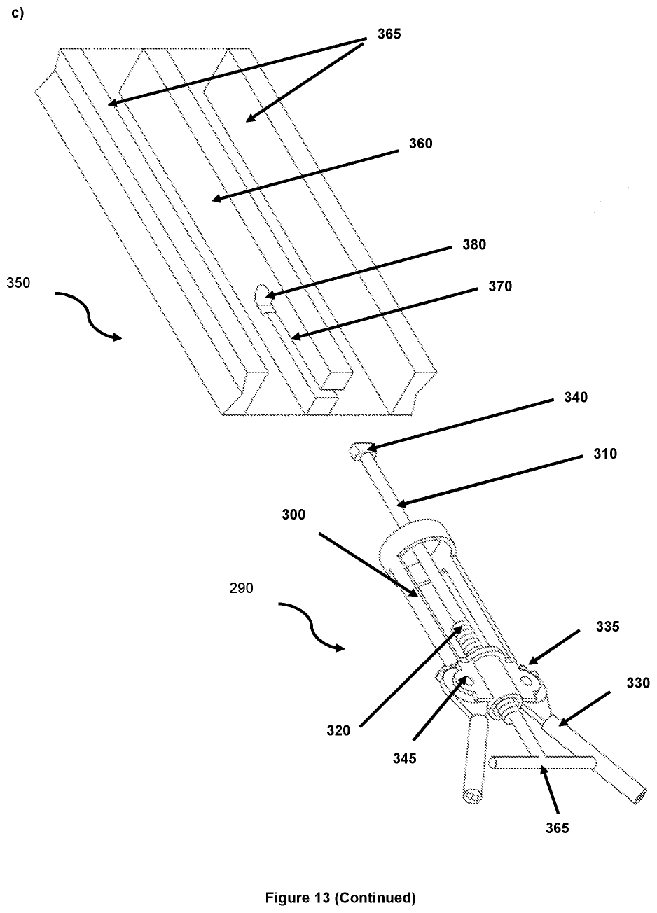

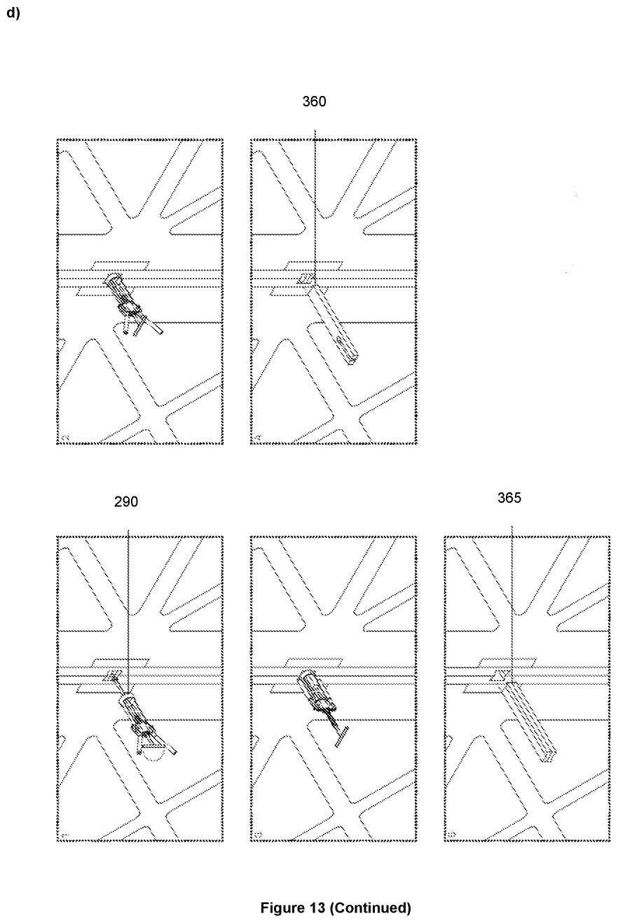

In embodiments, the peg or spline 10-L, 20-L, 30-L, 40-L, 170 is removable from the groove 180, i.e. it is a demountable joint. Any suitable means of removing the peg or spline 10-L, 20-L, 30-L, 40-L, 170 from the groove 180 is envisaged. Suitably, the peg or spline 10-L, 20-L, 30-L, 40-L, 170 may be removed by proprietary removal devices that are also an aspect of the present invention, embodiments of which are best seen in FIG. 13. Removal of the peg or spline 10-L, 20-L, 30-L, 40-L, 170 may be either from inside or outside of the building structure, or from the base side or the top or lid side of the cassette (depending on the cassette type and where used).

A first embodiment of a pull removal device 190 shown in FIG. 13a comprises a frame 200 comprising a drive screw 210 extending axially therethrough. The drive screw 210 is affixed at one end to a peg engagement claw 220, and at the other end, a handle 230 to facilitate rotation of the drive screw 210 in the frame 200. The drive screw 210 comprises a helical thread 240 along its length, the helical thread 240 engaging a corresponding helical thread 250 in a top end of the frame 200 distal from the peg engagement claw 220 such that on rotation of the drive screw 210, the drive screw 210 is drawn axially up and down the frame. The peg engagement claw 220 has a means of attachment 250 to the top of a peg or spline that that has been inserted in a groove between two cassettes. The means of attachment of the peg engagement claw 220 may suitably be a grub screw 260.

To remove a peg or spline 10-L, 20-L, 30-L, 40-L, 170 the drive screw 210 is rotated such that the peg engagement claw 220 is extended from the frame 200 to overlay and at least partially surround a head or an exposed end of the spline 10-L, 20-L, 30-L, 40-L, 170. The grub screw 260 is then tightened so that it pierces the head of the peg 10-L, 20-L, 30-L, 40-L, 170 allowing the peg engagement claw 220 to grip the head of the spline 10-L, 20-L, 30-L, 40-L, 170. Counter-rotation of the drive screw 210 then withdraws the spline 10-L, 20-L, 30-L, 40-L, 170 from the groove 180.

In this embodiment, to ensure the removal device can access the head of the spline 10-L, 20-L, 30-L, 40-L, 170, without the spline extending from the top or bottom edge of the outer cassette, a recess may be formed or cut at the edge of the outer cassette 140 that leaves the end of the spline accessible.

Once removed, the grub screw 260 can be loosened to release the removed peg 10-L, 20-L, 30-L, 40-L, 170 which may be re-inserted into the same groove 180 or re-used elsewhere.

The push removal device shown in FIG. 13b requires access to both sides of the cassette 10, 20, 30, 40. On one side, the end of the peg 10-L, 20-L, 30-L, 40-L, 170 is exposed, or one or more holes 270 are provided through a closed end of the groove 180 such that a suitable protrusion device 280 can be inserted to push the peg 10-L, 20-L, 30-L, 40-L, 170 from the groove 180 at the opposing end, on the other side of the cassette. Once removed the peg 10-L, 20-L, 30-L, 40-L, 170 may be re-inserted into the same groove 180 or re-used elsewhere.

A further embodiment of a pull peg removal device is shown in FIG. 13c. The removal device 290 resembles and acts like a known winged corkscrew with a frame 300, a drive member 310 having concentric rings 320 that act as gear teeth that engage at least one arm 330 which has corresponding gear teeth 335. The arms 330 are configured to rotate around a pivot point 345 adjacent the gear teeth 320 in the frame 300. The drive member 310 extends outward from the bottom of the frame 300, ending in an asymmetric widened tip 340 that is dimensioned perpendicular to the drive screw with a length that is greater than its width.

This embodiment of the pull peg removal tool is intended for use with an adapted peg or spline 350. The peg or spline 350 is formed in at least two, suitably three, parts allowing sequential removal of a central portion or block or section 360 of the peg 350, providing a gap into which the outer part(s), or portion 365 of the peg can drop into to be removed by hand. This arrangement has an advantage in that cutting of pegs or splines, such as 10-L, 20-L, 30-L, 40-L, 170 described above using standard techniques, such as CNC, often leaves a surface that is rougher, and therefore creates more friction between adjacent surfaces on removal as compared to paned-all-round (PAR) timber, or a block formed of biodegradable bio-resin, for example. This embodiment therefore allows removal of a central, generally rectangular block formed of PAR timber or bio-resin or the like with minimal frictional resistance prior to loosening of the other components of the peg by movement into the space vacated by the central block and removal, suitably by hand.

In the embodiment shown in FIG. 13c, the central portion 360 is provided with a shaped channel 370 that extends from one end face of the central portion 360 to a widened end 380 generally toward, in or near the middle of the central block 360.

As best seen in FIG. 13d, the channel is dimensioned such that the widened tip 340 of the removal device 290 can pass through in one complimentary orientation and into the widened end 380 of the channel 370 leaving the bottom of the frame 300 on or just above the surface of the peg and surrounding the central block 360. On rotation of the drive screw 310 relative to the central portion 360 using a handle 365 the asymmetric widened tip 340 is turned such that it becomes oriented largely perpendicular to the channel in a position that engages a proximal wall of the widened end 380. On retracting the drive screw, by rotating the arms about their axis in the manner of removing a cork using a winged corkscrew, the asymmetric widened tip applies force to the proximal wall of the widened end of the channel and the central portion 360 is retracted into the frame of the removal device. Once fully retracted, or retraced sufficiently, the central block may be pulled free by pulling on the removal device to which the central portion is engaged. Once the central block is removed, the outer parts 365 of the peg can be pushed into the space vacated by the central block and removed by hand. Once removed the peg 350 may be re-inserted into the same groove 180 or re-used elsewhere.

In all cases, once all required fixings (screws for RT&G strips and pegs or splines for spline joints) for the demountable cassettes are removed, an individual, or multiple cassettes may be removed from a larger structure with minimal, or no, wider disruption.

In embodiments of some types of cassettes, for example, wall cassettes 30, the combination of RT&G and spline joints may be sufficient to join two cassettes together with good alignment. Other types of cassettes, in particular those are intended to be mounted horizontally to span between supports, for example floor, intermediate floor, and roof cassettes may further require some form of demountable load-bearing joint to connect the cassettes at the unsupported abutment.

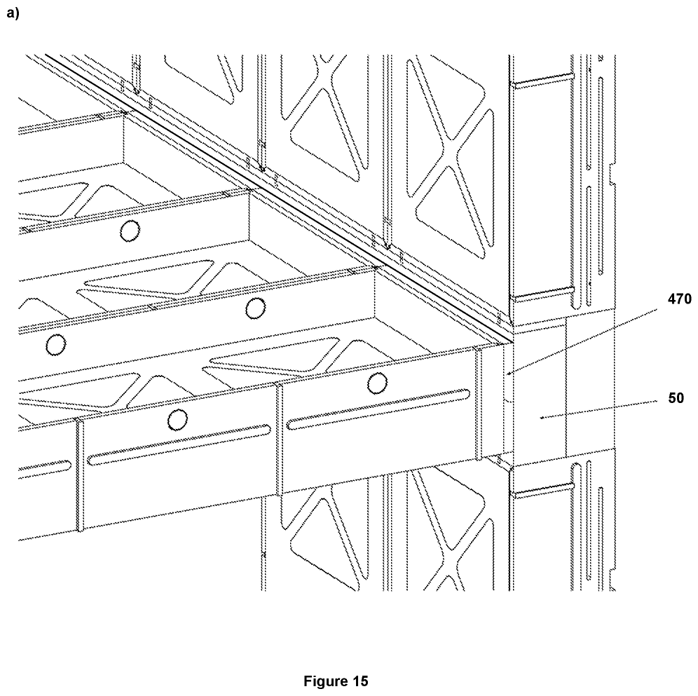

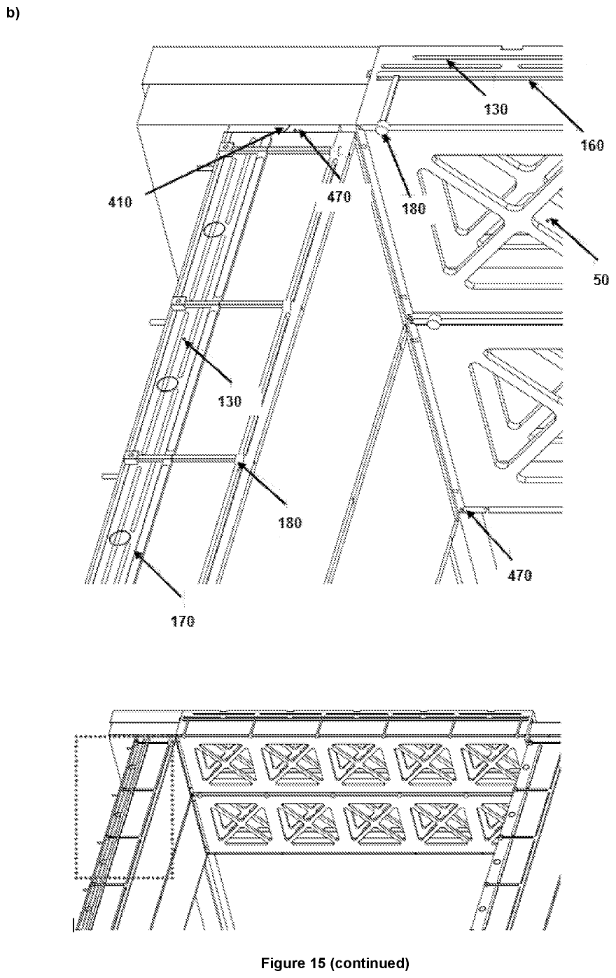

As best shown in the various views of FIG. 15, an embodiment of a demountable load-bearing joint is a split batten joint. A split batten joint is formed in two parts: on a first cassette, there is provided a first batten 390 (as shown in FIG. 15a or FIG. 15c) formed, fixed or bonded to an exterior of its outer cassette panel. Suitably, the first batten runs generally parallel to the base of the cassette. On a second cassette, or a support, or an intermediary cassette such as a junction cassette 50 described herein below, to which the first cassette is to be connected, would be a second batten (400 as shown in FIG. 15b or FIG. 15c) oriented to engage with and support the end of the first cassette once installed via its attached first batten 390.

Typically the first batten 390 and second batten 400 engage along a contacting edge 410. The contacting edge 410 being such that when engaged, typically overlapping with the first batten 390 overlaying, and supported on, the second batten 400, the first and second batten appear to be a single combined batten, hence the terminology of a ‘split batten’ joint.

Any shape of the first batten 390 and the second batten 400 at the contacting edge that leads to the first batten 390 being supported by the second batten 400 is envisaged. In embodiments, the first batten 390 and the second batten 400 are shaped at the contacting edge 410 such that the battens interlock. Suitably, the battens are shaped at the contacting edge such that the battens interlock and the joint is pulled tighter under load and/or the weight of gravity. Suitably, the battens are shaped to have a contacting edge that is sloped with respect to the plane of the outer cassette panel to which it is attached. Suitably, the first batten 390 has a contacting edge 410 that is sloped such that the length of the batten proximal to the outer cassette panel is shorter than the length of the batten distal to the outer cassette panel, and accordingly, the second batten has a contacting edge that is sloped such that the length of the batten proximal to the outer cassette panel is longer than the length of the batten distal to the outer cassette panel. Typically the first batten and/or the second batten extend substantially the full width of the cassette such that no gap is left at the joint that would allow air flow and subsequent heat loss.

Split batten joints may be used on one or both ends of a cassette allowing horizontally mounted cassettes to be removed individually (by lifting vertically thereby separating the one of more split batten joints) with no requirements for additional tools, and minimal or no disruption to surrounding or adjacent cassettes.

This type of split batten hanging joint requires no independent fixings and forms a robust, airtight joint under the weight of the panel once installed. Based on the desire to cut or form the components of a cassette from a single sheet of commonly available materials, an unsupported span of approximately 3 m is achievable with an arrangement of split batten joints at each end of a floor or roof cassette.

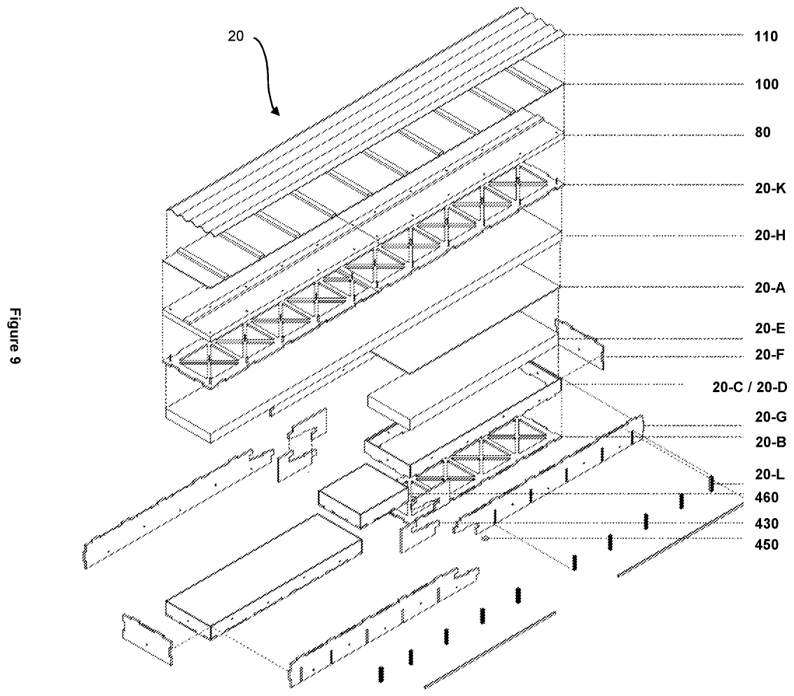

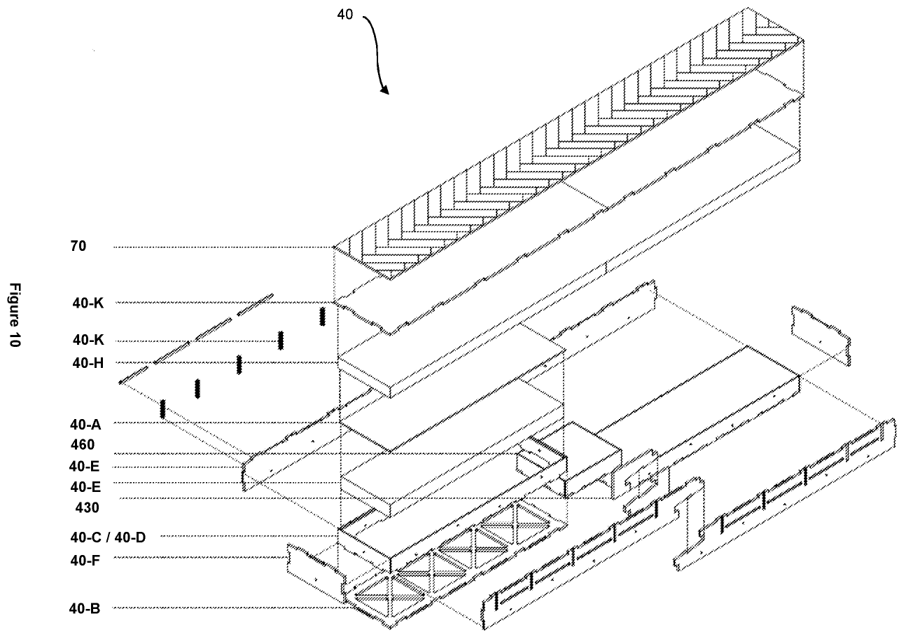

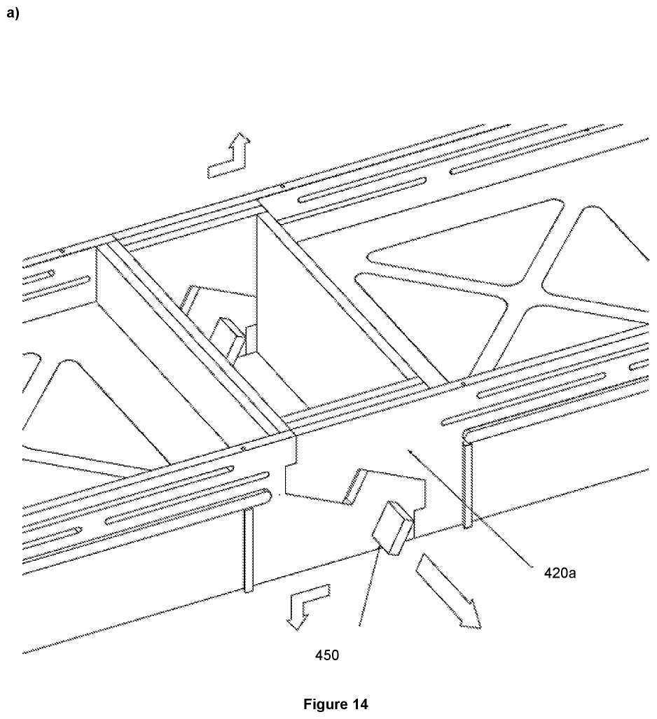

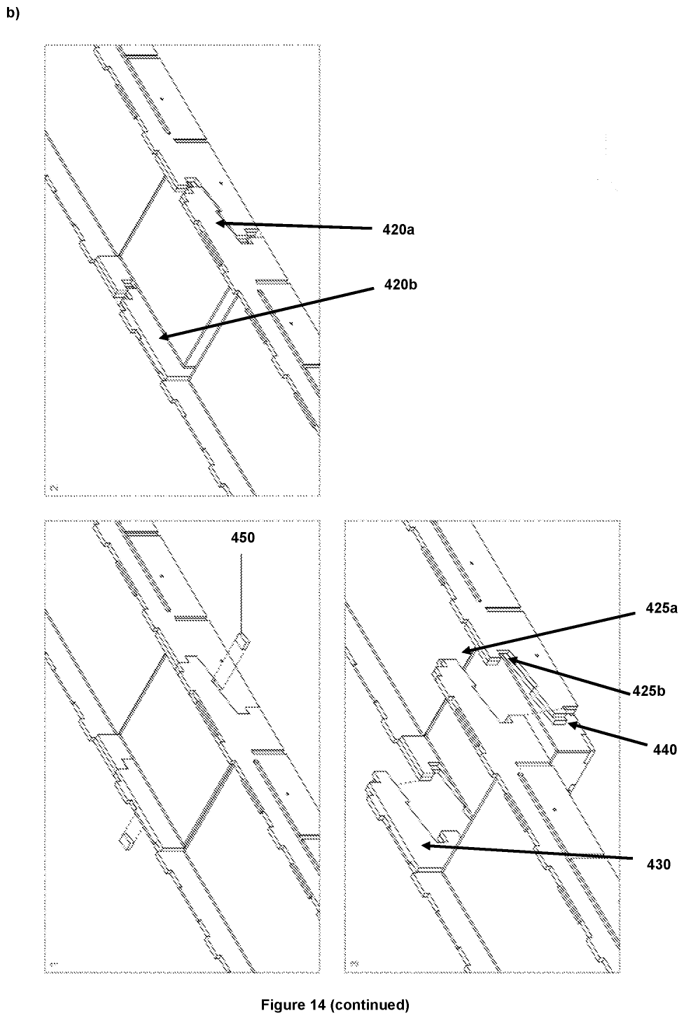

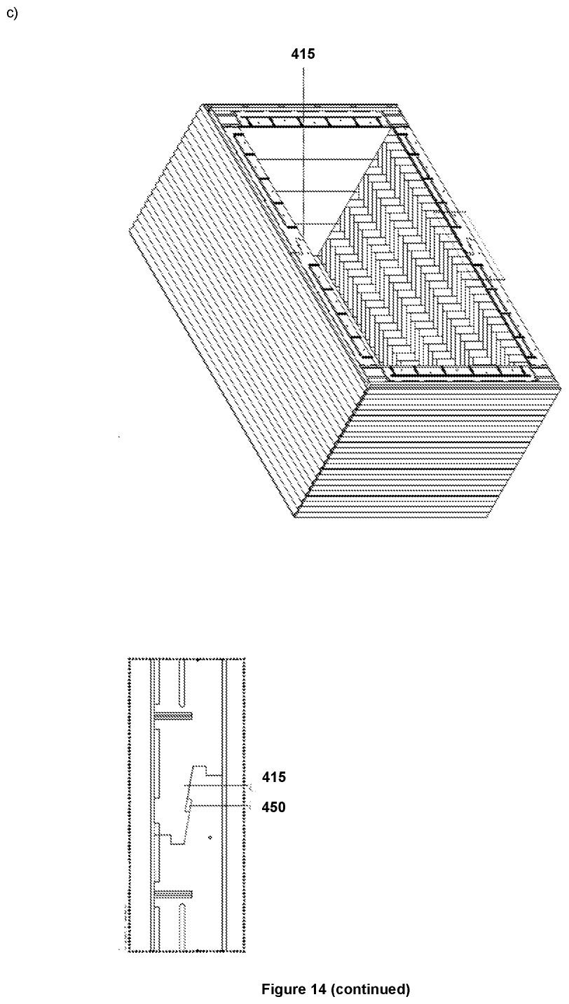

Any demountable joint that acts to support the cassettes and provide the structural integrity of the building structure formed is encompassed by the invention. In embodiments, the split batten joint may be replaced by a demountable interlocking scarf lock joint 415, optionally with a removable locking peg (FIGS. 9 and 14a-c). This type of joint may be particularly advantageous for wider unsupported horizontal spans, for example spans comprising two longitudinally arranged panels, up to a typical length of 6 m. In an embodiment of a demountable load-bearing joint of this type the side panels of the outer cassette extend beyond one end panel on each side. The extension 420a generally forms an inclined surface 430a that may lay on an opposingly-angled inclined surface 430b of an extension 420b on an adjacent cassette. The inclined surfaces of the extensions 420a and 420b are shaped such that the surfaces engage and thereafter prevent lateral disengagement without lifting at least one of the panels. In the embodiment shown in FIG. 14, the extensions 420a and 420b are shaped generally hook-like such that they may engage to prevent lateral movement or lateral separation of the cassettes.

In embodiments, a lock plate 430 is provided affixed to and supporting the extensions to the side panel that form the joint. Suitably, the lock plate is substantially the same shape as the extension and affixed to the extension, suitably on a face opposite the extension on the other side of the same cassette, to provide a wider contact zone between the cassettes when the joint is made. This provides greater structural rigidity and eases alignment of the cassettes when joined. In embodiments, the lock plate 430 may extend beyond the extension in at least one dimension, or at one or more points. As best shown in FIG. 14b, suitably, the lock plate 430 extends beyond the extension at an end away from or distal to the main side panel of the outer cassette to form a tab 440. This tab 440 prevents sideways or lateral movement of the cassettes with respect to each other when joined by the joint and adds further to the structural rigidity of the system.

In embodiments, the extension 420a is shaped such that there is a degree of longitudinal lateral movement (i.e. along a longitudinal axis that runs through both cassettes) in the plane of the cassette when it is engaged with an extension 420b of an adjacent cassette. When the cassettes are pushed together on final installation to provide an inter-engaged position, a protrusion 425a on the extension 420a, suitably the protrusion is at a distal end of extension 420a away from the end panel of the outer cassette, engages with a corresponding cut-out 425b on an adjacent cassette. Similarly a protrusion 425a on an extension 420b on an adjacent cassette engages with a corresponding cut-out 425b on the first cassette. The engagement of the protrusions 425a prevents either cassette being lifted to allow disengagement in this inter-engaged position.

At the same time, in embodiments, a space or gap or void 435 is formed on an inter-engaging surface of extension 420a and extension 420b such that a key block or pin 450 can be inserted into the space or gap to lock the joint in the inter-engaged position. In the locked position the scarf joint has minimal or no longitudinal movement in the plane of the cassettes, and also provides sufficient rigidity in the joint to prevent bending or sagging of the cassettes at the joint, under load. The scarf joint provides a supporting or load-bearing connection between the two cassettes without the aid of further supporting structures.

The key or pin 450 may be removed for disassembly of the joint and removal of either cassette. In embodiments, the key or pin 450 may be inserted or removed from the outside of the joint (i.e. on the face of a side panel of the outer cassette away from the other side panel of the same cassette. Additionally, or in alternative embodiments, the key or pin 450 may be inserted or removed from the inside of the joint.

In embodiments, the lock joints described hereinabove can be engaged as each cassette is installed. Alternatively, the lock joints may be made in advance of installation, either off-site, or on site, prior to installation of the joined cassettes.

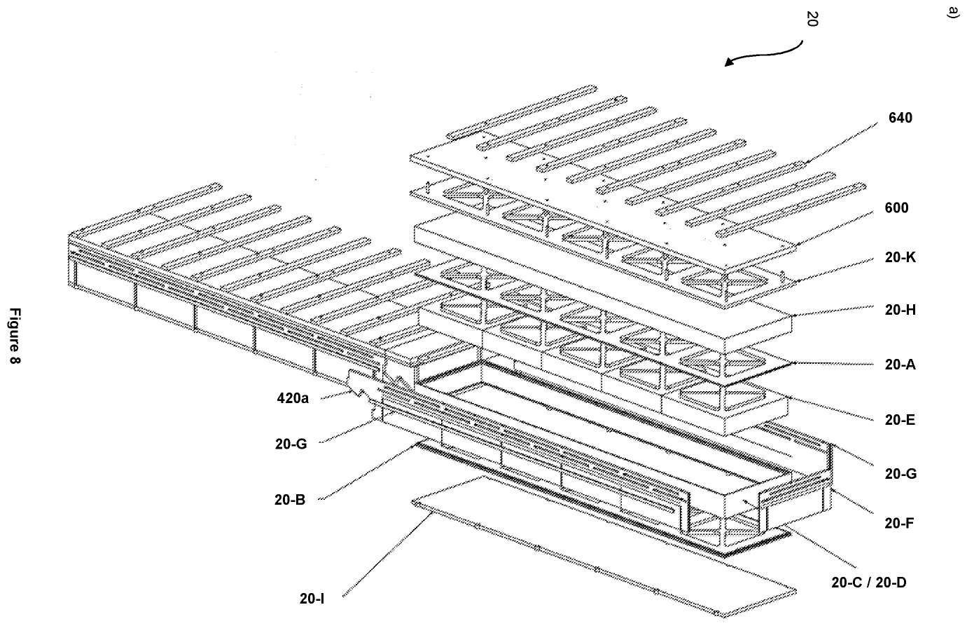

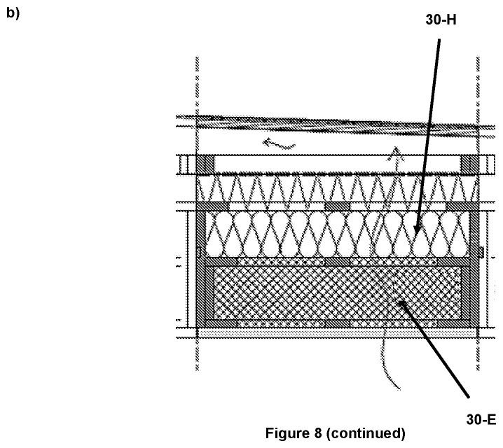

When cassettes are joined via a load-bearing lock joint as described above, for example as shown in FIGS. 8, 9 and 10, a gap is formed between the inter-locking extensions of the side panels of the outer cassettes. To maintain good insulation and sound proofing, and to maximise hygrothermal performance, this gap may be filled with an intermediate inner cassette 460. This inner cassette shares the properties of the inner cassette 120 of a main cassette 10, 20, 30, 40 as hereinbefore described, albeit dimensioned to fill the gap between the inner cassettes 120 of the main cassettes 10, 20, 30, 40. The intermediate inner cassette 460 may be joined to the inner cassette(s) 120 of the cassettes it is positioned between. In this arrangement, no end panel for the outer cassette at the end of the cassette having the extensions to the side panels is required.

In embodiments, and as best seen in FIG. 14c, once the required cassettes are installed in inter-locked jointed arrangement, insultation and finishing boarding may be added in accordance with other embodiments of the invention. In this embodiment, further insulation and boarding may be added as separate pieces over the intermediate inner cassette 460, or extended sections of insulation and/or boards that run from one end of a cassette away from the intermediate inner cassette 460 to a mid-point over the intermediate inner cassette 460 may be used. In this way, each individual cassette, or the jointed inter-locked group of cassettes may still be individually demounted as described elsewhere for other embodiments.

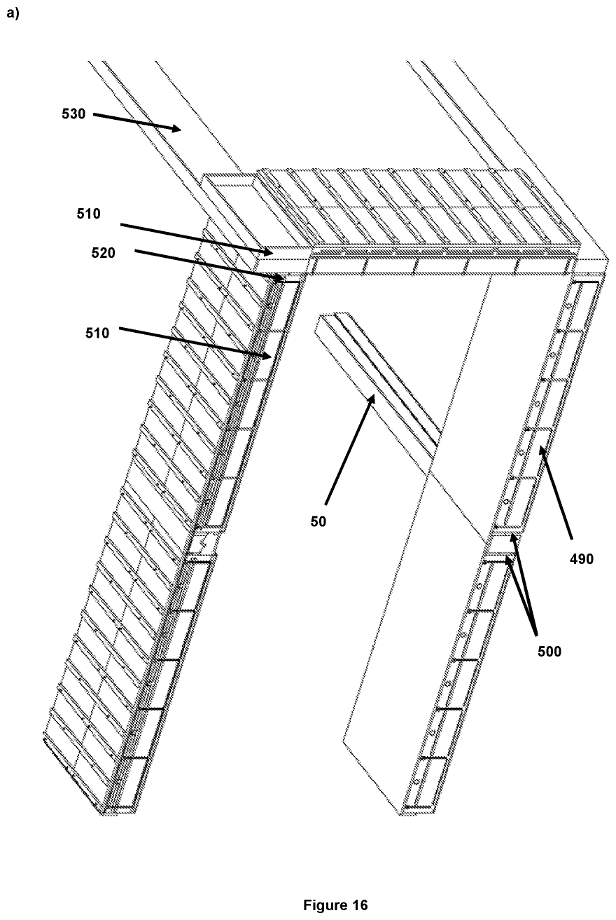

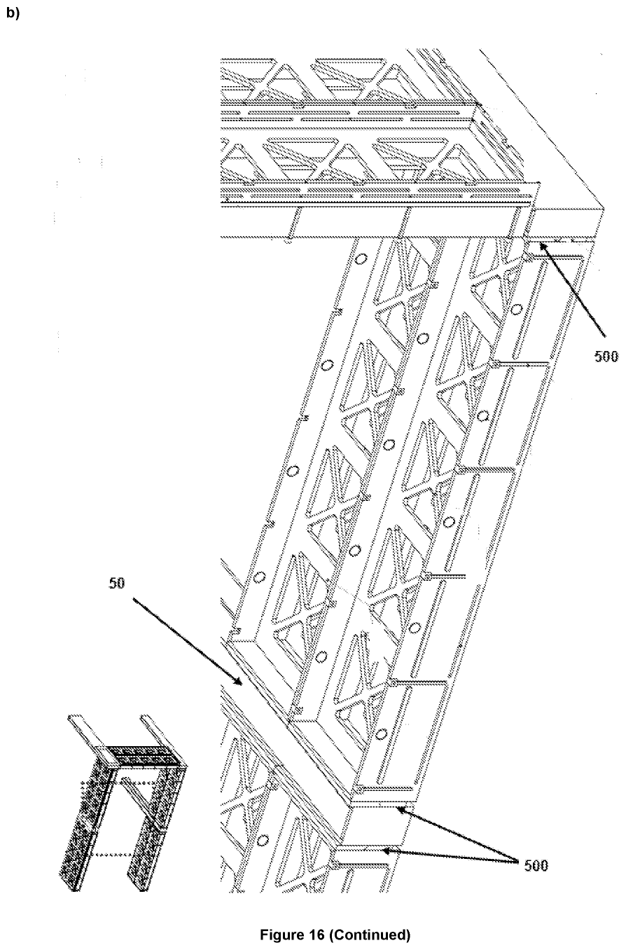

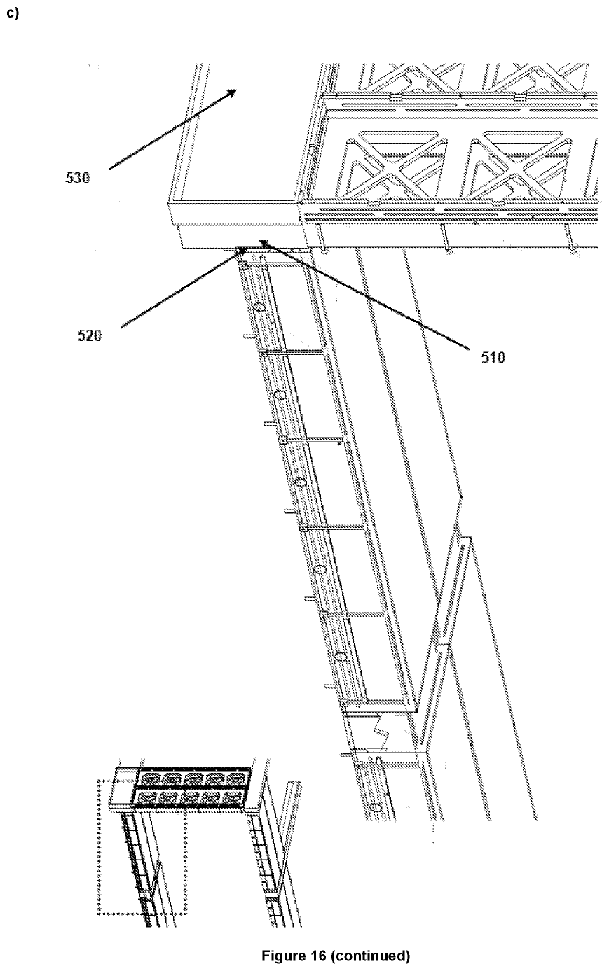

The demountable joints described herein may be formed directly between two cassettes (wall, roof, floor, or intermediate floor cassettes). As seen in FIGS. 16a-c, alternatively, the joints may be made through intermediate structures such as lintels or joists, or junction cassettes 50.

Junction cassettes 50 are generally optional components of the system that provide corresponding intermediary demountable fixings as described elsewhere herein at junctions between cassettes. The use of junction cassettes can simplify the construction process as the joints are made to smaller, more easily handled components. Further advantages may be realised in having modified or adapted junction cassettes 50 that have additional features such as lintels.

For higher structures, for example structures over 3 stories (see FIG. 3 for example), the junction cassettes that act as lintels etc may be replaced with solid beams formed of materials such as Laminated Veneer Lumber (LVL) or Glued Laminated Timber (glulam) and joined together with supporting column elements to provide primary structural support for the cassettes. Other materials such as concrete, steel or flitch beam may also be used although this would have an impact on the carbon footprint of the building.

An example of a lintel intermediate demountable joint is shown in FIGS. 16a and 16b. Split batten joints described elsewhere herein is visible on the lower horizontal section of the structure shown. However, rather than the split batten joint being between two adjacent cassettes, there are two split batten joints, one on each side of a suitably shaped floor joist 480. The flooring finishing board is then sized to extend across both the cassette and the joist to provide a flat and even surface

In addition, in FIG. 16a, a lower or floor junction cassette 490 is used as an intermediate structure in the split batten joint 500 between a floor cassette and a lower end of a wall cassette, and a different embodiment of a roof or upper junction cassette 510 is used as an intermediate structure in the split batten joint 520 between the roof cassette and an upper end of the wall cassette. The upper junction cassette, in this embodiment, incorporates a lintel structure 530. The lintel structure may extend over a gap in the wall structure, for example over a window variant of the wall cassette 30.

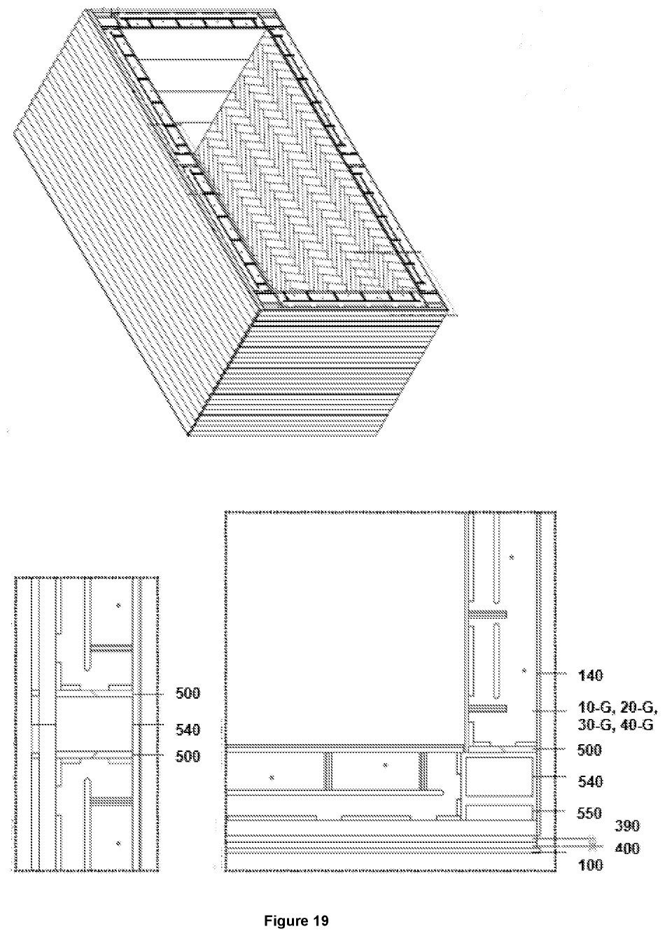

While junction boxes 50 may take any form suitable to take the loads required, as best seen in FIG. 19, in embodiments, junction boxes 50 are essentially box beams 540 (hollow beams with a square or rectangular cross-section) with the required jointing sections attached thereto. Junction boxes may comprise runners or channels 550 therethrough to accommodate services such as electrical cabling, water pipes, waste pipes etc., or ventilation. In embodiments, the channels in the junction boxes are open or accessible under the finishing board or cladding to the exterior of the wall, roof or floor. This allows the services to be readily accessible for maintenance, additions, or removal/replacement,

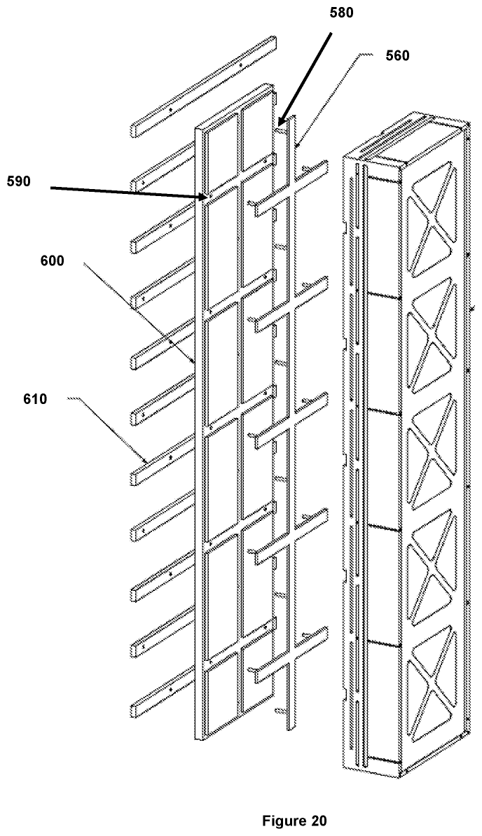

Cassettes intended for use on an exterior of a building, for example cassettes for exterior walls or roofs, may require robust weatherproofing and additional insulation to the exterior facing side. As shown in FIG. 20a, rigid insulation may be mounted to the exterior facing side of the outer cassette 140 by means of a frame 560, suitably a wooden frame, or lattice board (depending on the required structural capacity of the cassette). The wooden frame or lattice board may comprise apertures or holes in a similar manner to the lid and/or base of the inner cassette to maintain free movement of water vapour through the cassette.

In embodiments, dowels 580, suitably wooden dowels are mounted on the frame to protrude through pre-formed holes 590 in the rigid insulation 600. Suitably, battens 610 are then mounted on the exterior facing side of the rigid insulation 600 to hold it in place and allow for its removal, either together with the frame/lattice board 560 or separately. The rigid insulation 600 may be formed to accommodate the frame or lattice board, minimising the height of the cassette, increasing rigidity and protecting the insulation from handling damage.

In FIG. 6, and best shown in FIG. 20b an alternative embodiment of the cladding panels where the rigid insulation 600 is affixed to the outer face of the cassette is shown, which is essentially the board base of the inner cassette. Insulation battens 620 are then fixed to the rigid insulation 600. These battens are shown vertical in FIG. 20b but they could be in any orientation that provides the required spacing/air gap. Cladding 630 in panels affixed to cladding battens 640, may then be offered up to and affixed to the cassette by means of suitable fixings, suitably removeable fixings such as screws or clips to allow for ready removal.

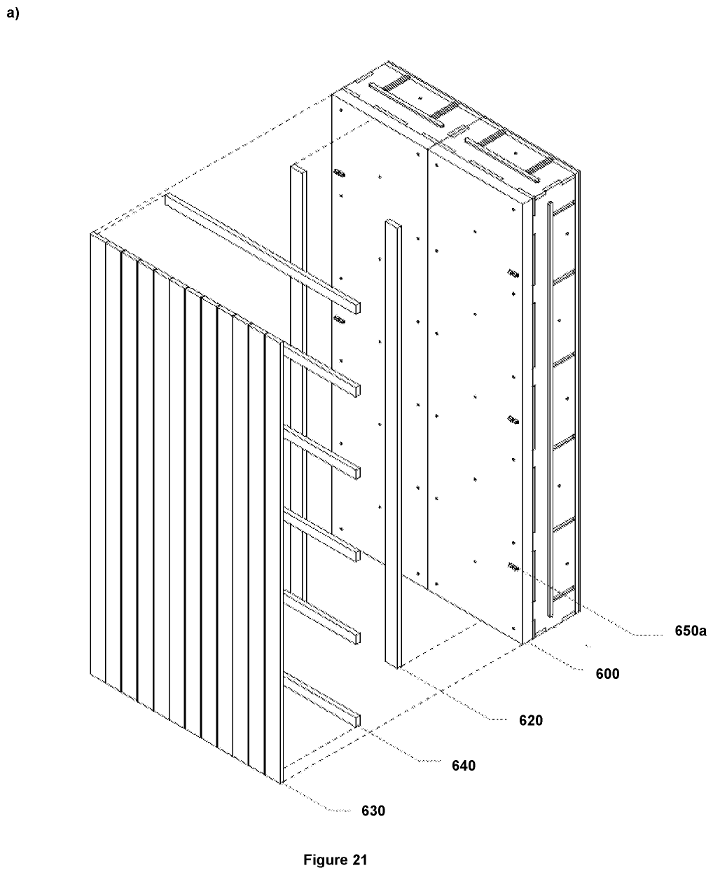

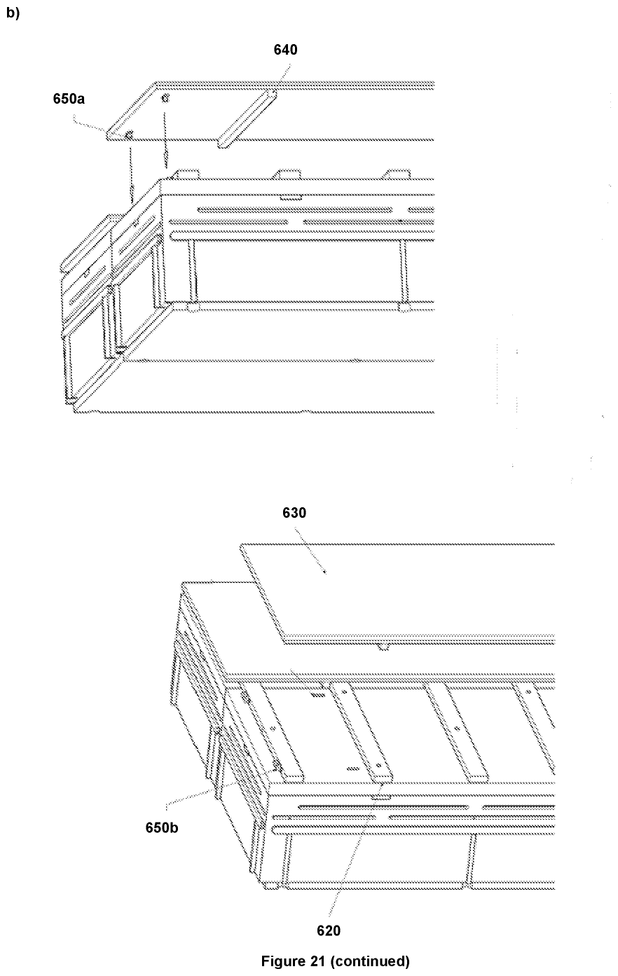

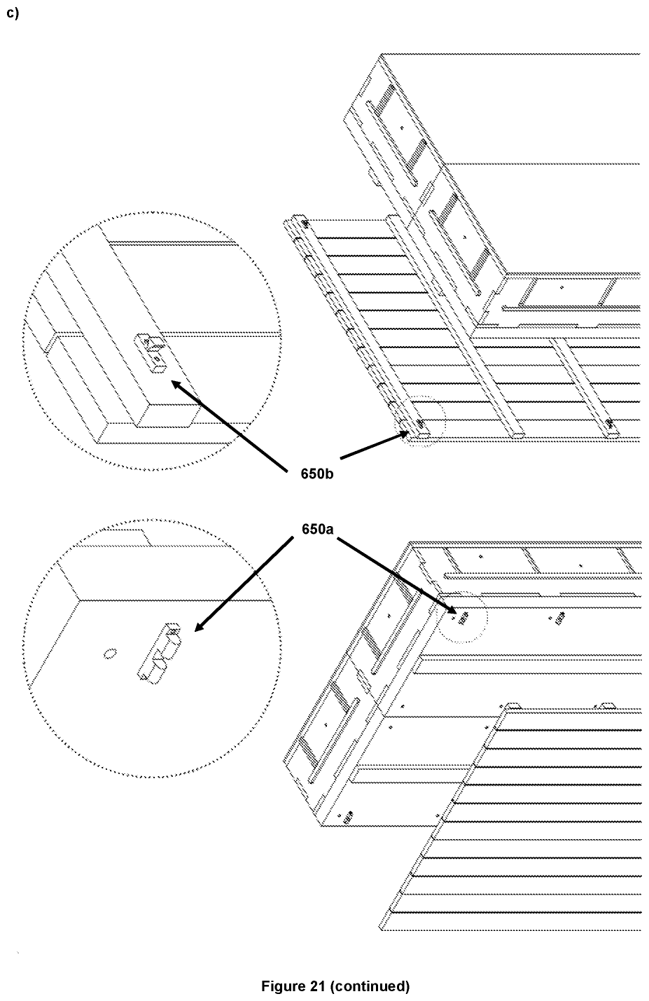

As best seen in FIGS. 21a and 21b, one suitable means of fixing the cladding 630 to the cassette is via removable clips 650a and 650b.

Demountable exterior cladding may be fixed to and supported by the clips and/or battens allowing for a ventilated zone and sheathing materials if required.

The cassettes 10, 20, 30, 40 of the present invention may be prepared off-site and supplied partly or fully assembled as volumetric modules, or they may be provided as individual cassettes, flat packed, or part assembled as panelised units with assembly completed on-site. Either volumetric and panelised construction, or a combination of both, may be used to complete a building structure, depending on access to site, ability to use the required equipment such as cranes or telehandlers, and cost and/or convenience.

An open inner cassette is assembled comprising two-side panels, two end panels and a base. Insulation blocks are then installed or cast or moulded within the inner cassette before the lid is affixed to form the inner cassette 120. The joints between components of the inner cassette are suitably lock mitre joints 125 to avoid the use of independent, metal or plastic or otherwise non-biodegradable, fixings. Typically lock mitre joints require adhesive or glue to secure the joint. While most glues do not impact in the biodegradability of components which they affix, biodegradable or compostable glues may be considered. The outer cassette is then assembled on the inner cassette by overlaying and bonding with a suitable adhesive, the outer cassette side panels and end panels over the corresponding panels of the inner cassette. Once set, further insulation, such as natural fibre insulation, may be inserted into a void in the outer cassette such that it overlays the inner cassette.

For cassettes that are not exposed to the external environment, such as intermediate floor cassettes, the cassette may then be finished on both faces with a suitable finishing board such as breathable board or flooring depending on the application.

For cassettes that are exposed to the external environment, or where further insulation is required, further rigid insulation and cladding may be added at this stage as described above.

The method of installing and demounting a cassette is also an aspect of the present invention and varies depending on the use and position of the cassette within the structure.

For wall or other vertically mounted cassettes (including wall and window cassettes) there is no requirement for load-bearing demountable joints between adjacent panels. Therefore, demountable jointing is limited to the spline joints for preventing movement between the installed cassettes.

It is a particular advantage of the system of the present invention that the demountable joints between each cassette, or between a cassette and a support such as a wall on an adjacent building, provide sufficient structural rigidity to a structure built using the cassettes on their own without the need for additional support, such that the cassettes can provide the primary structural support. As the height of the building increase, further structural support may be required but this is in addition to that provided by the cassette joints and is provided through the junction cassette/lintel structures described elsewhere herein.

In embodiments, the invention further provides a method of installing and/or removing a cassette in accordance with the present invention. The method of installation of a cassette may vary depending on whether the cassettes is mounted such that it has an orientation that is vertical (i.e. the cassette forms part of a wall structure), or horizontally (i.e. the cassette forms part of a roof or floor structure). The terms ‘vertical’ and ‘horizontal’ in this context refers to the orientation of the top and bottom surfaces of a cassette as intended to be installed in a building structure. For ease of notation, although not limited by the description, vertical cassettes may be termed “wall cassettes” and horizontal cassettes refer to roof and/or floor cassettes.

In embodiments, the method of installing a wall cassette may comprise the steps of:
1) providing a wall cassette, wherein the wall cassette comprises an inner cassette and an outer cassette, the outer cassette comprising one or more open channels; one or more tongue strips or other protrusions; and one or more grooves;
2) installing the wall cassette by aligning the wall cassette such that the one or more tongue strips on the outer cassette aligns with and engages one or more grooves on an adjacent wall cassette, wherein the or each of the one or more open channels on the outer cassette aligns with one or more open channels on the adjacent cassette to form a slot;
3) optionally repeat steps 1 and 2 to install further wall cassettes as required adjacent to the wall cassette;
4) insert pegs, or splines, into the slots to join the wall cassette to the or each adjacent cassette.

In embodiments, installation of a wall cassette may further comprise after step (4), one or more of:
5) Install mechanical and electrical services
6) install further insulation in the outer cassette;
7) attach the cladding frame, rigid insulation and cladding finishing an interior face of the cassette.

In embodiments, the one or more tongue strips may align with and engage a groove on another structure that is not a cassette of the present invention, Suitably, the structure may be a groove on a junction cassette, a floor joist, a plinth, or a lintel.

Finishing each face in step 7 comprises inserting plugs and/or covers over the pegs or splines to allow for easy access, and/or fitting any boarding and/or insulation and/or cladding to a given face of the cassette dependent on its intended purpose. Finishing may also include applying an adhesive tape to joints and a layer of plaster or render over one or more surfaces of the cassette.

In embodiments, the method of demounting or removing a wall cassette is generally the reverse of installation, the method generally comprising the steps of:
1) providing an installed wall cassette, wherein the wall cassette comprises an outer cassette, the outer cassette comprising one or more open channels;
2) removing any finishing panels or interior plugs from at least one face of the wall cassette;
3) removing the splines from the one or more open channels;
4) accessing the interior of the outer cassette;

5) releasing a tongue strip, or other protrusion, affixed to the outside of the wall cassette from the interior of the cassette;
6) accessing the interior of the outer cassette of any adjacent cassettes which have tongue strips inserted into the wall cassette and releasing a tongue strip for each;
7) remove the wall cassette.

In embodiments, step (3) and steps (4), (5) and (6) may be reversed.

In embodiments, removing any finishing may also encompass separating the wall cassette from adjacent cassettes and other building structures, for example, scoring plasterwork around the edge of the cassette to enable its removal with minimal disruption to the surrounding area.

In embodiments, accessing the interior of the outer cassette in step 4 may encompass removing the exterior cladding a rigid insulation.

For floor or other horizontally mounted cassettes (including floor, intermediate floor and roof cassettes) there is a requirement for load-bearing demountable joints between adjacent panels, i.e. joints that can support the weight of the cassette and any load placed upon it. Therefore, demountable jointing is used to prevent movement between the installed cassettes, and also to support the cassettes under load.

In embodiments, the method of installing a floor cassette (which the same as an intermediate floor cassette or a roof cassette), the method comprising the steps of:
1) providing a floor cassette, wherein the floor cassette comprises an outer cassette, the outer cassette comprising one or more open channels; one or more tongue strips or other protrusions; and one or more grooves;
2) installing the floor cassette by aligning to an adjacent cassette such that the tongue strip aligns with and engages a groove on the adjacent cassette, and lowering the cassette on to demountable joints located at each end of the floor cassette, wherein the or each of the one or more open channels aligns with an open channel on the adjacent cassette to form a slot;
3) install further cassettes as required adjacent to the floor cassette;
4) insert splines into the slots to join the floor cassette to the or each adjacent cassette;
5) Install finishing to each face of the cassette.

In embodiments, finishing each face in step (7) comprises fitting any external boarding and/or insulation and/or cladding to a given face of the cassette dependent on its intended purpose.

In embodiments the method of demounting a floor cassette (which the same as an intermediate floor cassette or a roof cassette) is generally the reverse of installation, the method generally comprising the steps of:
1) providing an installed floor cassette, wherein the wall cassette comprises an outer cassette, the outer cassette comprising one or more open channels;
2) removing any finishing from the exterior or upward facing side of the floor cassette;
3) removing one or more splines from one or more open channels;
4) accessing the interior of the outer cassette;
5) releasing a tongue strip, or other protrusion, affixed to the outside of the floor cassette;
6) accessing the interior of the outer cassette of any adjacent cassettes which have corresponding tongue strips inserted into the floor cassette and releasing the tongue strip for each;
7) lifting the floor cassette thereby separating the one or more demountable joints.

In embodiments, steps (3) and steps (4), (5) and (6) may be reversed.

The methods of installing and removing cassettes as described above may apply for any cassette in accordance with the invention as herein described. Junction cassettes may be removed in a similar manner by removing any corresponding jointing to attached cassettes.

The readily demountable cassette construction system of the present invention allows for easy removal, replacement, and re-use of individual cassettes. This means building made with the system can be easily adapted and renovated without the need for significant disruption or waste. An informal ‘circular economy’ of cassettes and components will be encouraged to promote second hand re-use of all parts of the system. Should disposal of the cassettes ultimately be required, the main structural components of the cassettes are almost exclusively made, or at least can be made, of wood. Wood is naturally biodegradable. Other component such as the insulation can be chosen to be biodegradable such as the use of hemp-lime or other biodegradable breathable insulation materials, or natural fibre insulation. This means that the cassettes can be disposed of in appropriate waste streams with minimal or no long-term impact in the environment.

The cassettes of the present invention also allow for control of the heat and water vapour levels in the building through use of hygrothermally optimised materials.

Although particular embodiments of the invention have been disclosed herein in detail, this has been done by way of example and for the purposes of illustration only. The aforementioned embodiments are not intended to be limiting with respect to the scope of the invention. It is contemplated by the inventors that various substitutions, alterations, and modifications may be made to the invention without departing from the spirit and scope of the invention.

1. A demountable cassette construction system for building a structure comprising one or more demountable cassettes, wherein the or each of the one or more demountable cassettes are attachable to one or more adjacent demountable cassettes via demountable joints, wherein the demountable joints permit the one or more demountable cassettes to be removed from a structure without removal of and/or damage to the or each of the one or more adjacent demountable cassettes.

2. The demountable cassette construction system of claim 1, wherein the demountable joints consist of biodegradable components.

3. The demountable cassette construction system of claim 2, wherein the demountable joints consist of wooden components.

4. The demountable cassette construction system of any one of claims 1 to 3, wherein the demountable joints lack any non-biodegradable fixings selected from the group consisting of: screws, nails, non-wooden brackets, and combinations thereof.

5. The demountable cassette construction system of any one of claims 1 to 4, wherein the demountable joints are selected from the group consisting of: split-batten joints; scarf joints and spline joints.

6. The demountable cassette construction system of claim 5, wherein the scarf-joints are scarf lock joints

5. The demountable cassette construction system of claim 5 or claim 6, wherein the spline joints are bow-tie joints.

8. The demountable cassette construction system of any one of claims 1 to 7, wherein the or each of the one or more demountable cassettes further comprises a demountable means of alignment with the or each of the one or more adjacent demountable cassettes.

9. The demountable cassette construction system of claim 8, wherein the means of alignment is a removeable tongue on the or each of the one or more demountable cassettes and a corresponding groove on the or each of the one or more adjacent demountable cassettes.

9. The demountable cassette construction system of claim 9, wherein the removeable tongue is removeable from within an interior volume of the or each demountable cassette.

11. The demountable cassette construction system of any one of claims 1 to 10, wherein the one or more demountable cassettes are selected from the type consisting of: a wall cassette; a floor cassette; an intermediate floor cassette; a roof cassette; and a junction cassette.

11. The demountable cassette construction system of claim 11, wherein the system comprises:
a. At least one floor cassette;
b. At least two wall cassettes;
c. At least one roof cassette.

13. A demountable cassette for use in a demountable cassette construction system of claim 1 to 12.

14. The demountable cassette of claim 13, wherein the cassette comprises:
a. an inner cassette, the inner cassette comprising: a base; a lid; two opposing, generally parallel end panels, and two opposing, generally parallel side panels arranged to enclose an interior space, wherein the interior space contains insulation;
b. an outer cassette surrounding an exterior of, and affixed to, the inner cassette, the outer cassette comprising at least one end panel, and two opposing, generally parallel side panels;
c. at least one demountable joint, or part thereof, for joining the demountable cassette to an adjacent structure

15. The demountable cassette of claim 14, wherein the at least one demountable joint, or part thereof, is positioned on a part of cassette selected from the group consisting of: an end panel of the outer cassette; a side panel of the outer cassette, or a combination of both.

16. The demountable cassette of claim 14 or claim 15, wherein the adjacent structure is selected from the group consisting of: a demountable cassette; a junction cassette; a lintel; a floor joist; and a plinth or combinations thereof.

17. The demountable cassette of any one of claims 14 to 16, wherein the cassette comprises a demountable means of alignment on at least one of the side panels of the outer cassette.

18. The demountable cassette of any one of claims 14 to 17, wherein the cassette is of a type selected from the group consisting of: a wall cassette; a floor cassette; and a roof cassette.

19. The demountable cassette of claim 18, wherein when the cassette is a floor cassette or a roof cassette, the demountable joints on the end panel support the weight of the cassette in use.

20. The demountable cassette of any one of claims 14 to 19 wherein the insulation fills the interior space of the inner cassette.

21. The demountable cassette of any one of claims 14 to 20, wherein the lid and/or base of the inner cassette permits passage of water vapour between the insulation and the surrounding air.

22. The demountable cassette of claim 21, wherein the insulation is breathable and/or has good hygrothermal properties

23. The demountable cassette of claim 21 of claim 22, wherein the inner cassette comprises apertures in the lid and/or the base, or the lid and/or base of the inner cassette is vapour permeable to allow movement of water vapor between the insulation with the surrounding air.

23. The demountable cassette of claim 23, wherein the insulation extends into the apertures in the lid and/or base of the inner cassette.

25. A method for preparing a demountable cassette for use in a demountable cassette construction system, the method comprises the steps of:
a. providing an open inner cassette, wherein the inner cassette comprises a lid;
b. installing one or more insulation blocks into the inner cassette and affixing the lid to provide an inner cassette;
c. affixing an outer cassette to at last partially surround the inner cassette, the outer cassette having walls that extend upwardly from a top of the inner cassette such that a void is provided within the volume defined by the outer cassette; the outer cassette having at least one demountable joint, or part thereof, for joining the demountable cassette to an adjacent structure.

26. The method of claim 25, further comprising the steps after step (b) of:
d. installing insulation in the void;
e. affixing a finishing board to at least one face of the outer cassette.

27. A method for installing a vertically mounted cassette as part of a demountable cassette construction system, the method comprising the steps of:
a. providing a first cassette, wherein the first cassette comprises an inner cassette and an outer cassette, the outer cassette comprising one or more open channels; one or more tongue strips; and one or more grooves;
b. providing a second cassette, wherein the second cassette comprises an inner cassette and an outer cassette, the outer cassette comprising one or more open channels; one or more tongue strips; and one or more grooves;
c. installing the first cassette by aligning the first cassette such that at least one of the one or more tongue strips on the outer cassette aligns with and engages at least one of the one or more grooves on the second cassette, wherein at least one of the or each of the one or more open channels on the outer cassette of the first cassette aligns with at least one of the one or more open channels on the second cassette to form a slot;
d. insert splines into the slots to join the first cassette to the second cassette.

28. The method of claim 27, wherein the method further comprises one or more of the following steps after step (d):
e. install mechanical and electrical services as required;
f. install further insulation in the outer cassette as required; and/or
g. install finishing boards to a top face and/or a bottom face of the cassette.

29. The method of claim 27 or claim 28, wherein the vertically mounted cassette is a wall cassette.

30. A method of demounting a vertically mounted cassette as part of a demountable cassette construction system, the method comprising the steps of:
a. providing an installed first cassette adjacent and fixed to a second cassette,
wherein the first cassette comprises an inner cassette and an outer cassette, the outer cassette comprising one or more open channels one or more tongue strips; and one or more grooves, and the second cassette comprises an outer cassette, the outer cassette comprising one or more open channels one or more tongue strips; and one or more grooves,
wherein at least one of the one or more open channels of the first cassette and at least one of the one or more open channels of the second cassette align to provide one or more slots, wherein in the one or more slots is inserted one or more splines that hold the first cassette and the second cassette together; and
wherein at least one of the one or more tongue strips of the first cassette are engaged with at least one of the one or more grooves on the second cassette;
b. removing the splines from the one or more slots;
c. accessing the interior of the outer cassette of the first cassette;
d. releasing the one or more tongue strips on the first cassette;
e. removing the first cassette.

31. The method of demounting a vertically mounted cassette of claim 30, wherein step (b) and steps (c) to (d) may be reversed.

30. e method of demounting a vertically mounted cassette of claim 30 or claim 31, wherein the vertically mounted cassette is a wall cassette.

33. The method of demounting a vertically mounted cassette of any one of claims 30 to 32, wherein finishing in step (e) comprises fitting any external boarding and/or insulation and/or cladding to a given face of the cassette dependent on its intended purpose.

34. A method of installing a horizontally mounted cassette as part of a demountable cassette construction system, the method comprising the steps of:
a. providing a first cassette, wherein the first cassette comprises an inner cassette and an outer cassette, the outer cassette comprising one or more open channels; one or more tongue strips, and one or more grooves;
b. providing a second cassette, wherein the second cassette comprises an inner cassette and an outer cassette, the outer cassette comprising one or more open channels; one or more tongue strips, and one or more grooves;
c. installing the first cassette by aligning to the second cassette such that at least one of the one or more tongue strip on the first cassette aligns with and engages with at least one of the one or more grooves on the second cassette, and engaging the first cassette on to demountable joints located at an end of the first cassette and an end of the second cassette, wherein at least one of the one or more open channels on the first cassette aligns with at least one of the one or more of the open channels on the second cassette to form a slot;
d. insert splines into the slots to join the first cassette to the second cassette;
e. install finishing boards to the first cassette.

35. The method of installing a horizontally mounted cassette of claim 34, wherein the horizontally mounted cassette is a floor cassette.

36. The method of installing a horizontally mounted cassette of claim 34, wherein the horizontally mounted cassette is a roof cassette.

37. The method of installing a horizontally mounted cassette of any one of claims 34 to 36, wherein finishing in step (e) comprises fitting any external boarding and/or insulation and/or cladding to a given face of the cassette dependent on its intended purpose.

38. A method of demounting a horizontally mounted cassette as part of a demountable cassette construction system, the method comprising the steps of:
a. providing an installed first cassette adjacent and fixed to a second cassette,
wherein the wall cassette comprises an inner cassette and an outer cassette, the outer cassette comprising one or more open channels; one or more tongue strips; and one or more grooves; and the second cassette comprises an inner cassette and an outer cassette, the outer cassette comprising one or more open channels one or more tongue strips, and one or more grooves,
wherein at least one of the open channels of the first cassette and at least one of the one or more open channels of the second cassette align to provide one or more slots, wherein in the one or more slots is inserted one or more splines that hold the first cassette and the second cassette together; and
wherein at least one of the one or more tongue strips of the first cassette are engaged with at least one of the one or more grooves on the second cassette;
b. removing the one or more splines from the one or more slots;
c. accessing an interior of the outer cassette of the first cassette;
d. releasing the or each of the one or more tongue strips affixed to the outside of the first cassette;
e. lifting the first cassette thereby separating the one or more demountable joints.

39. The method of claim 38, wherein step (b) and steps (c) to (d) may be reversed.

40. The method of claim 38 or claim 39, wherein the horizontally mounted cassette is a floor cassette.

41. The method of claim 38 or claim 39, wherein the horizontally mounted cassette is a roof cassette.

42. A method of assembling a building structure using the system of claims 1 to 12 and/or one or more of the cassettes of any one of claims 13 to 24.

43. A building structure assembled using the method of claims 27 to 29, the method of claims 34 to 37, the system of claims 1 to 12 and/or one or more of the cassettes of claims 13 to 24.

44. The building structure of claim 43, wherein the building structure is over 18 metres high.

45. A method of deconstructing, demolishing, reconfiguring, renovating or extending a building structure previously assembled using the system of claims 1 to 12, the cassette of claims 13 to 24 or the method of any one of claims 27 to 41.
